(19) United States
(12) Patent Application Publication
(10) Pub. No.: US 2026/0131475 A1
(43) Pub. Date: May 14, 2026

(54) ROBOT SYSTEM, CONTROL METHOD FOR ROBOT SYSTEM, PRODUCT MANUFACTURING METHOD, AND RECORDING MEDIUM

(71) Applicant: CANON KABUSHIKI KAISHA, Tokyo (JP)

(72) Inventor: MOTOHIRO HORIUCHI, Kanagawa (JP)

(21) Appl. No.: 19/378,629

(22) Filed: Nov. 4, 2025

(30) Foreign Application Priority Data
Nov. 13, 2024 (JP) 2024-198295

(51) Int. Cl. B25J 9/16

(52) U.S. Cl. CPC B25J 9/1697; B25J 9/1612

(57) ABSTRACT

A robot system includes a robot including an end effector, a sensor configured to detect a state of one or more workpieces disposed in a workpiece storage portion, and a control apparatus configured to control the robot. The control apparatus is configured to execute selection processing to select a target workpiece serving as a holding target of the end effector from the one or more workpieces by using a detection result obtained from the sensor, information processing to obtain, by using the detection result, information of a region to which the target workpiece in the workpiece storage portion is movable, in a case where a holding condition that is required for the end effector to hold the target workpiece is not satisfied, and control processing to control the robot such that the end effector comes into contact with the target workpiece to move the target workpiece to the region.

### BACKGROUND

### Field of the Technology

The present disclosure relates to robot technology.

### Description of the Related Art

Robot control to cause a robot to pick up one by one a plurality of workpieces randomly piled up in a workpiece storage portion is known. However, there may be a case where a workpiece present at an end of the workpiece storage portion cannot be picked up by the robot because the robot interferes with the wall of the workpiece storage portion or the like even if the workpiece can be recognized by a camera. If some workpieces remain in the workpiece storage portion, there is a possibility that the number of replacements of the workpiece storage portion required for manufacturing a predetermined number of products increases, thus it takes time to manufacture the predetermined number of products, and the production efficiency of the product deteriorates.

To address this, Japanese patent Application Laid-Open No. 2012-183616 discloses a workpiece supply apparatus including a protrusion portion movable upward from an inner bottom surface of a container body. In addition, Japanese Patent Application Laid-Open No. 2001-179669 discloses causing a robot to perform an operation of pulling a part closer to the center of a box in the case where the robot fails to grip the part.

However, although the state of the workpiece can be changed in either of Japanese Patent Application Laid-Open No. 2012-183616 and Japanese Patent Application Laid-Open No. 2001-179669, after the state of the workpiece is changed, the workpiece is not necessarily in a state in which the workpiece can be held by the robot.

### SUMMARY

The present disclosure provides a technique advantageous for a robot to hold a workpiece.

According to a first aspect of the present disclosure, a robot system includes a robot including an end effector, a sensor configured to detect a state of one or more workpieces disposed in a workpiece storage portion, and a control apparatus configured to control the robot. The control apparatus is configured to execute selection processing to select a target workpiece serving as a holding target of the end effector from the one or more workpieces by using a detection result obtained from the sensor, information processing to obtain, by using the detection result, information of a region to which the target workpiece in the workpiece storage portion is movable, in a case where a holding condition that is required for the end effector to hold the target workpiece is not satisfied, and control processing to control the robot such that the end effector comes into contact with the target workpiece to move the target workpiece to the region.

According to a second aspect of the present disclosure, there is provided a control method for a robot system including a robot including an end effector, a sensor configured to detect one or more workpieces disposed in a workpiece storage portion, and a control apparatus configured to control the robot. The control method includes causing the control apparatus to select a target workpiece serving as a holding target of the end effector from the one or more workpieces by using a detection result obtained from the sensor, causing the control apparatus to obtain, by using the detection result, information of a region to which the target workpiece in the workpiece storage portion is movable, in a case where a holding condition that is required for the end effector to hold the target workpiece is not satisfied, and causing the control apparatus to control the robot such that the end effector comes into contact with the target workpiece to move the target workpiece to the region.

Features of the present disclosure will become apparent from the following description of embodiments with reference to the attached drawings. The following description of embodiments is described by way of example.

### BRIEF DESCRIPTION OF THE DRAWINGS

FIG. 1A is an explanatory diagram of a robot system according to a first embodiment.

FIG. 1B is an explanatory diagram illustrating a state of the inside of a workpiece storage portion as viewed from a sensor according to the first embodiment.

FIG. 2 is a block diagram of a hardware configuration of a robot controller according to the first embodiment.

FIG. 3 is a functional block diagram of the robot controller according to the first embodiment.

FIG. 4 is a control flowchart of the robot controller according to the first embodiment.

FIG. 5 is an explanatory diagram of a gripping point according to the first embodiment.

FIG. 6 is a control flowchart of workpiece moving processing according to the first embodiment.

FIG. 7 is a schematic diagram for describing an empty region according to the first embodiment.

FIG. 8 is a schematic diagram for describing a selection method for contact information according to the first embodiment.

FIG. 9 is a schematic diagram for describing processing to calculate an operation amount of an end effector according to the first embodiment.

FIG. 10 is an explanatory diagram of the operation of the end effector realized by an operation plan of the first embodiment.

FIG. 11 is a flowchart of processing to calculate contact information according to the first embodiment.

FIG. 12 is a concept diagram for describing a calculation method for candidates of the contact information according to the first embodiment.

FIG. 13 is an explanatory diagram of processing to determine whether or not an entrance condition is satisfied according to the first embodiment.

FIG. 14 is a schematic diagram for describing determination of interference between the workpiece storage portion and the end effector according to the first embodiment.

FIG. 15 is a schematic diagram for describing determination of interference between the end effector and a workpiece in the workpiece storage portion according to the first embodiment.

FIG. 16 is a schematic diagram for describing a method for setting candidates of contact information according to the first embodiment.

FIG. 17 is an explanatory diagram of the end effector according to the first embodiment.

FIG. 18 is an explanatory diagram of a three-dimensional model according to the first embodiment.

FIG. 19 is a flowchart illustrating processing to set candidates of contact information according to the first embodiment.

FIG. 20 is a schematic diagram for describing a method for determining whether or not a moment is generated according to the first embodiment.

FIG. 21 is a schematic diagram for describing processing to set candidates of contact information according to the first embodiment.

FIG. 22 is a schematic diagram for describing rotation of a three-dimensional model of the end effector according to the first embodiment.

FIG. 23 is a schematic diagram for describing interference determination according to the first embodiment.

FIG. 24 is a flowchart of processing to recognize an empty region according to the first embodiment.

FIG. 25 is a schematic diagram of an image generated by an environment recognition portion according to the first embodiment.

FIG. 26 is a schematic diagram of the image generated by the environment recognition portion according to the first embodiment.

FIG. 27 is a schematic diagram of a distance image according to the first embodiment.

FIG. 28 is a schematic diagram of a binary image according to the first embodiment.

FIG. 29 is an explanatory diagram illustrating a maximum distance of a minimum empty region according to the first embodiment.

FIG. 30 is a schematic diagram of the image generated by the environment recognition portion according to the first embodiment.

FIG. 31 is an explanatory diagram of information processing of another example according to the first embodiment.

FIG. 32 is an explanatory diagram of an example of a display image according to the first embodiment.

FIG. 33 is an explanatory diagram of an example of a display image according to the first embodiment.

FIG. 34 is a flowchart illustrating processing to set candidates of contact information according to a second embodiment.

FIG. 35 is a flowchart for performing processing to move a workpiece out of a path according to a third embodiment.

FIG. 36 is a schematic diagram for describing processing according to the third embodiment.

FIG. 37 is a schematic diagram for describing a distance calculation method according to the third embodiment.

FIG. 38 is an explanatory diagram of training data according to a fourth embodiment.

FIG. 39 is an explanatory diagram of inference according to the fourth embodiment.

FIG. 40 is an explanatory diagram of masking processing according to the fourth embodiment.

### DESCRIPTION OF THE EMBODIMENTS

### Configuration of System

Embodiments of the present disclosure will be described below with reference to drawings.

For the description, terms are defined as follows. “Position” indicates a three-dimensional vector of (x, y, z) indicating a point based on a Euclidean coordinate system. “Posture” indicates a 3×3 rotation matrix for, among two Euclidean coordinate systems, superimposing one Euclidean coordinate system on the other.

### First Embodiment

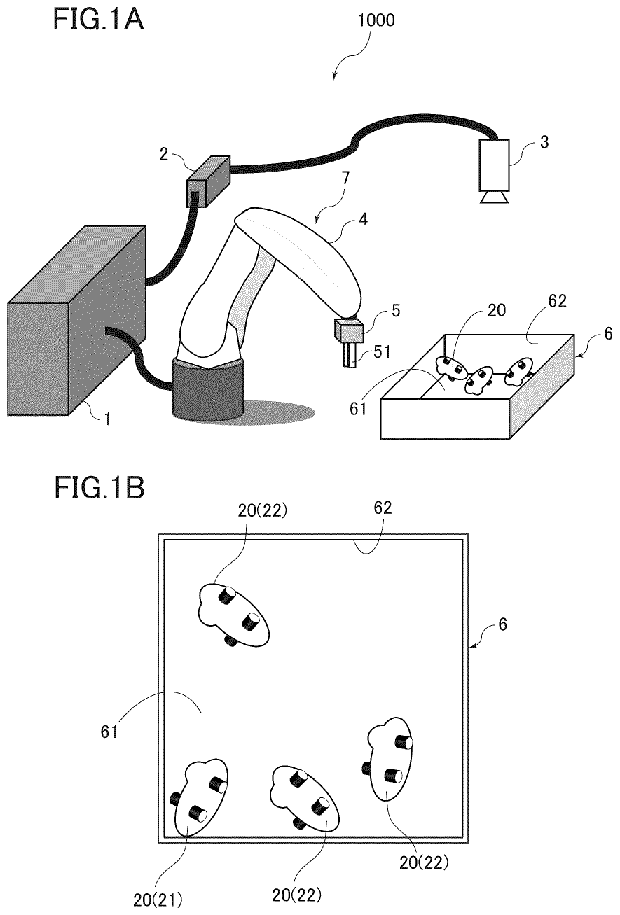

FIG. 1A is an explanatory diagram of a robot system 1000 according to the first embodiment. The robot system 1000 includes a robot 7, a robot controller 1 connected to the robot 7 and configured to control the robot 7, a sensor controller 2 connected to the robot controller 1, and a sensor 3 connected to the sensor controller 2. The robot controller 1 is an example of a control apparatus.

A workpiece storage portion 6 is a storage container of a box shape whose top side is open, and is capable of storing a plurality of workpieces 20 randomly piled up. For example, the workpiece storage portion 6 includes an inner bottom surface 61 serving as a placement surface on which the workpieces 20 are placed, and an inner wall surface 62 disposed at the outer periphery of the inner bottom surface 61. The plurality of workpieces 20 each can be a holding target for the robot 7. In addition, the plurality of workpieces 20 each have the same shape and size.

For example, the robot 7 is an industrial robot. The robot 7 can perform a predetermined manufacturing work by conveying the workpiece 20. The predetermined manufacturing work is, for example, an assembly work of coupling a workpiece 20 to another workpiece. The robot 7 performs the predetermined manufacturing work, and thus a manufactured product serving as an example of a product is manufactured. The product may be a final product or an intermediate product. The robot 7 includes a robot arm 4, and an end effector 5 provided at a distal end portion of the robot arm 4 serving as an example of a predetermined portion. The robot arm 4 is, for example, a vertically-articulated robot arm. The end effector 5 is, for example, a robot hand. The robot hand includes a parallel chuck including two fingers 51, and can open and close the two fingers 51 on the basis of a command value from the robot controller 1 similarly to the robot arm 4. To be noted, the end effector 5 may be, for example, a vacuum gripper that holds the workpiece 20 by suction attraction.

The sensor 3 is disposed above the workpiece storage portion 6 at a position where the entirety of the opening of the workpiece storage portion 6, that is, the entirety of the inner bottom surface 61 is within the field of view of the sensor 3. The sensor 3 is fixed to, for example, an unillustrated frame.

In the first embodiment, the sensor 3 is an image pickup apparatus such as a digital camera. The sensor 3 generates image information as detection information. The detection information is a detection result. The sensor 3 can be a depth sensing camera, for example, an RGBD camera. The depth sensing camera generates image information (image data) including depth information as detection information.

To be noted, the sensor 3 may be a sensor that generates detection information from which the robot controller 1 can obtain the placement state (for example, information of position and posture) of the workpiece 20 disposed on the inner bottom surface 61 of the workpiece storage portion 6. For example, the sensor 3 may be an RGB camera that generates image information not including the depth information. In addition, the sensor 3 may be fixed to the robot arm 4. In addition, the sensor 3 may be a depth sensor using infrared light, and depth information may be generated as the detection information by scanning the inside of the workpiece storage portion 6 using infrared light. As described above, the sensor 3 detects a workpiece that is visible from the sensor 3 among the plurality of workpieces 20 disposed inside the workpiece storage portion 6, that is, on the inner bottom surface 61, and the detection information is output to the robot controller 1 via the sensor controller 2.

FIG. 1B is an explanatory diagram illustrating the state inside the workpiece storage portion 6 as viewed from the sensor 3 according to the first embodiment. To be noted, in the example of FIG. 1B, most of the plurality of workpieces 20 that are piled up have been taken out by the robot 7, and one or more workpieces 20 are still in the workpiece storage portion 6. Further, part of the inner bottom surface 61 of the workpiece storage portion 6 not overlapping with the one or more workpieces 20 is exposed as viewed from the sensor 3. Therefore, in the example of FIG. 1B, the sensor 3 detects the state of the inner bottom surface 61 of the workpiece storage portion 6 and the one or more workpieces 20 disposed on the inner bottom surface 61, and outputs the detection information thereof to the robot controller 1 via the sensor controller 2. A case where the one or more workpieces 20 are stored in the workpiece storage portion 6 as in the example of FIG. 1B will be described below.

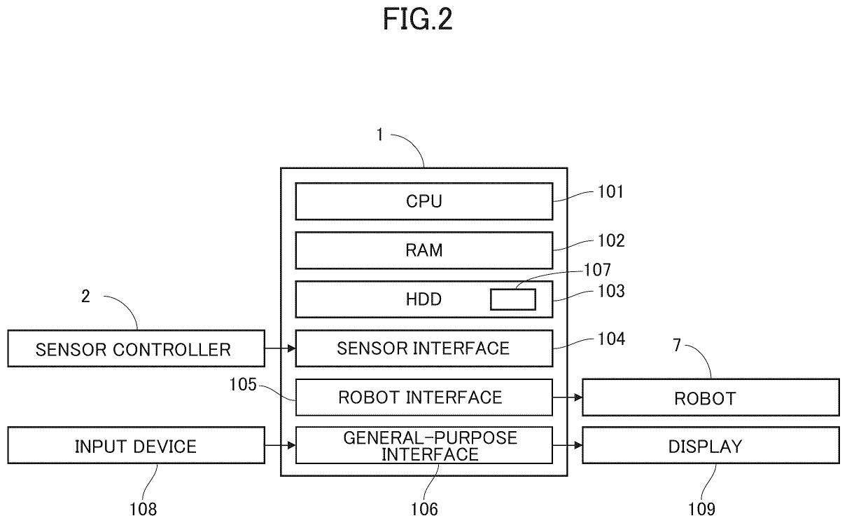

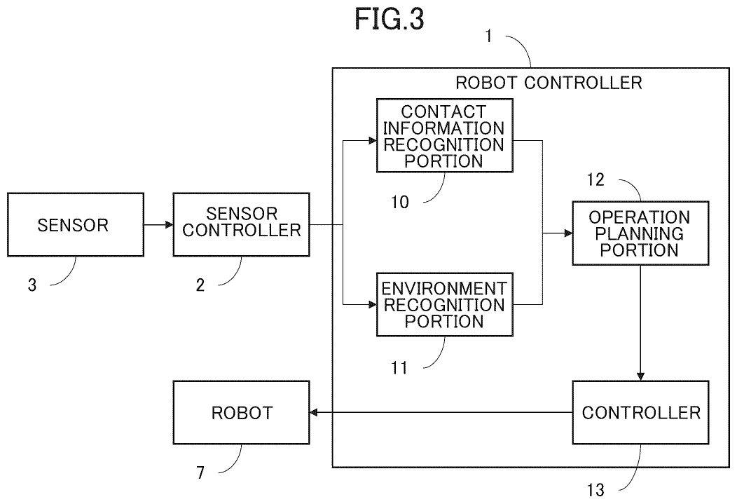

FIG. 2 is a block diagram of a hardware configuration of the robot controller 1 according to the first embodiment. FIG. 3 is a functional block diagram of the robot controller 1 according to the first embodiment. The robot controller 1 includes a central processing unit (CPU) 101 serving as an example of a processor. In addition, the robot controller 1 includes a random access memory (RAM) 102 as a primary storage device, and a hard disk drive (HDD) 103 as a secondary storage device. To be noted, the RAM 102 and the HDD 103 are each an example of a storage device, and the storage device is not limited to these examples.

The CPU 101 functions as a contact information recognition portion 10, an environment recognition portion 11, an operation planning portion 12, and a controller 13 illustrated in FIG. 3 by executing a program 107. The program 107 is stored in the HDD 103 serving as a secondary storage device.

In addition, the robot controller 1 includes a sensor interface 104, a robot interface 105, and a general-purpose interface 106 as connection interfaces with external devices. The sensor interface 104 is connected to the sensor controller 2, and enables communication of information with the sensor controller 2. The robot interface 105 is connected to the robot 7, and enables communication of information with the robot 7. The general-purpose interface 106 is an interface with external devices of various uses, and corresponds to a universal serial bus (USB), a high-definition multimedia interface (HDMI (registered trademark)), or the like. For example, the general-purpose interface 106 is connected to an input device 108 such as a mouse and a keyboard and to a display 109, receives information from the input device 108, and transmits image information to the display 109. The sensor interface 104 and the robot interface 105 may be of standards corresponding to the sensor controller 2 and the robot 7, and may be a general-purpose interface of Ethernet or the like. These components of the robot controller 1 are interconnected by a bus so as to be capable of mutually communicating data.

To be noted, although the non-transitory computer-readable recording medium is the HDD 103 and the program 107 is stored in the HDD 103 in the present embodiment, the configuration is not limited to this. The program 107 may be stored in any recording medium as long as the recording medium is a non-transitory computer-readable recording medium. Examples of recording media that can be used as a recording medium for supplying the program 107 to the computer include a flexible disk, a hard disk, an optical disk, a magneto-photo disk, a magnetic tape, and a nonvolatile memory. In addition, the program 107 may be obtained from an unillustrated network.

The contact information recognition portion 10 and the environment recognition portion 11 illustrated in FIG. 3 are connected to the sensor controller 2, and can receive detection information (value) generated by the detection processing by the sensor 3 from the sensor controller 2. In the case where the sensor 3 is an image pickup apparatus such as a camera, the detection information is image information obtained by imaging.

To be noted, although the sensor 3 is constituted by one camera in the present embodiment, the configuration is not limited to this, and may be constituted by, for example, two cameras respectively connected to the contact information recognition portion 10 and the environment recognition portion 11.

The contact information recognition portion 10 and the environment recognition portion 11 are each configured to transmit a recognition result to the operation planning portion 12. The operation planning portion 12 is configured to plan the operation of the robot arm 4 and the end effector 5 on the basis of the received information and transmit the operation plan to the controller 13. The controller 13 converts the received operation plan into a robot command value, and transmits the robot command value to the robot arm 4 or the end effector 5. The robot arm 4 having received the robot command value operates in accordance with the received robot command value, and the end effector 5 having received the robot command value operates in accordance with the received robot command value.

### Summary of Robot Operation

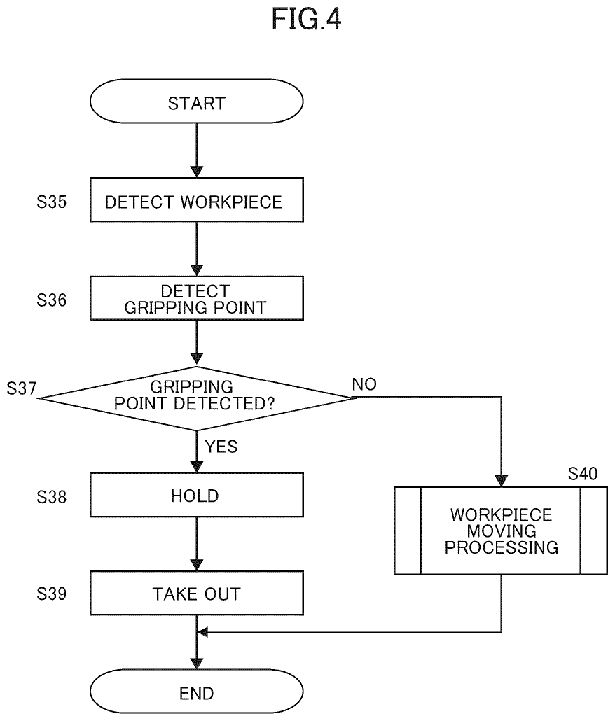

FIG. 4 is a control flowchart of the robot controller 1 according to the first embodiment. By repeatedly executing the control cycle illustrated in FIG. 4, the plurality of workpieces 20 are taken out one by one from the workpiece storage portion 6 by the robot 7. A state in which one or more workpieces 20 are still in the workpiece storage portion 6 as illustrated in FIG. 1B will be described. The robot controller 1 performs control to cause the robot 7 to pick up the one or more workpieces 20 stored in the workpiece storage portion 6.

First, in step S35, the robot controller 1 causes the sensor controller 2 to execute the detection processing by the sensor 3, and obtains detection information that is a detection result from the sensor 3. The robot controller 1 detects one or more workpieces 20 in the workpiece storage portion 6 by using the detection information. That is, the robot controller 1 obtains presence information of the workpiece 20 in the workpiece storage portion 6. The presence information is information indicating the positional coordinates (x, y, z) of the workpiece 20 on the basis of the coordinate system of the sensor 3 (sensor coordinate system). Then, the robot controller 1 selects one target workpiece 21 serving as a holding target from the one or more workpieces 20 disposed on the inside of the workpiece storage portion 6. The target workpiece 21 may be randomly selected from the one or more workpieces 20, or may be selected in accordance with a priority order given to the one or more workpieces 20. The processing of step S35 is an example of selection processing.

In the case where the one or more workpieces 20 are one workpiece, the workpiece is selected as the target workpiece 21. In the case where the one or more workpieces 20 are two or more workpieces, one of the two or more workpieces is selected as the target workpiece 21. In this case, workpieces 22 other than the target workpiece 21 in the two or more workpieces can be the target workpiece 21 in later control cycles.

As the method for detecting the workpiece 20, various methods can be applied. For example, in the case where a depth sensor is used as the sensor 3, the workpiece 20 can be detected by sampling depth information in the workpiece storage portion 6 obtained by scanning into point cloud information and performing matching processing with a three-dimensional model of the workpiece 20. In addition, in the case where an RGB camera is used as the sensor 3, the workpiece 20 may be detected by using a machine learning algorithm such as single-shot detector (SSD) that detects the presence of an object.

Next, in step S36, the robot controller 1 executes processing to detect a gripping point of the target workpiece 21 selected in step S35 where the end effector 5 can hold the target workpiece 21. The storage device such as the HDD 103 stores workpiece information (three-dimensional model) of the workpiece 20 and a plurality of candidates of the gripping point associated with the workpiece information, and the CPU 101 of the robot controller 1 extracts a gripping point where the end effector 5 can hold the target workpiece 21 from the plurality of candidates of the gripping point.

The gripping point is information including information of the position and posture of the end effector and information of the opening degree of the two fingers 51 with which the end effector 5 can hold the workpiece 20 without dropping the workpiece 20 when the end effector 5 is moved to the vicinity of the workpiece 20 and the fingers 51 of the end effector 5 are opened or closed. The position and posture of the end effector 5 are, for example, the position and posture based on the workpiece coordinate system.

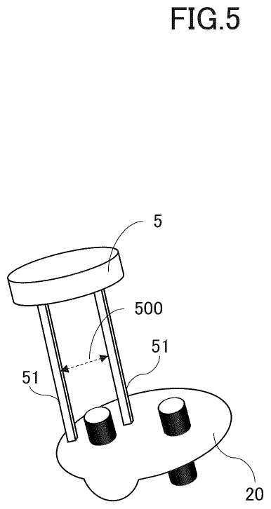

FIG. 5 is an explanatory diagram of the gripping point according to the first embodiment. The gripping point illustrated in the example of FIG. 5 is information of the position and posture of the end effector 5 and the information of the opening degree of the two fingers 51 of the end effector 5 in a state in which the two fingers 51 of the end effector 5 by a predetermined width indicated by an arrow 500, and the end effector 5 is moved to the vicinity of the workpiece 20. The end effector 5 can hold the workpiece 20 as a result of the end effector 5 moving to the gripping point and performing the holding operation to close the two fingers 51.

Here, in the case where the holding operation of closing the two fingers 51 of the end effector 5 is performed at the gripping point, the two fingers 51 respectively come into contact with two points on the workpiece 20. Two normal line vectors directed inward with respect to the workpiece 20 at the two points need to face each other. The condition for the two normal line vectors to face each other is, for example, that an angle formed by the two normal line vectors is within the range of 180°±1°. ±1° is the allowable range. To be noted, the allowable range is not limited to ±1°, and for example, may be set to an arbitrary value by the user. However, since the possibility for the end effector 5 to stably hold the workpiece 20 is lowered as the allowable range is wider, the allowable range may be ±1°.

In addition, the end effector 5 and the workpiece 20 must not interfere (for example, collide) with each other before and during the holding operation by the end effector 5 at the gripping point.

The gripping point in the case where the end effector 5 includes a parallel chuck of two fingers has been described above, but the configuration is not limited to this. For example, in the case where the end effector 5 is a vacuum gripper that performs vacuum suction attraction or the like, the gripping point is information of the position and posture of the end effector 5 where the end effector 5 can hold the workpiece 20 by coming into contact with the workpiece 20 and performing suction.

In addition, the plurality of candidates of the gripping point are calculated in advance by using 3D simulation or the like on one workpiece, and is stored in the storage device such as the HDD 103 in association with the workpiece information. Since the plurality of candidates of the gripping point are set in the workpiece coordinate system, the robot controller 1 can easily detect the gripping point from the plurality of candidates of the gripping point by calculating the position and posture of the target workpiece 21 detected in step S35.

To be noted, the calculation of the position and posture of the target workpiece 21 can be performed by, for example, processing such as pattern matching in the case where the sensor 3 is an RGB camera. In addition, the calculation can be performed by using 3D matching used in step S35 also in the case where the sensor 3 is a depth sensing camera.

As described above, in step S36, a gripping point including the position and posture to which the robot arm 4 can move and where the robot 7 does not interfere with the workpiece storage portion 6, the workpieces 22 other than the target workpiece 21 serving as the holding target, and the like is selected from the plurality of candidates of the gripping point stored in the HDD 103 or the like.

In step S37, the robot controller 1 determines whether or not a holding condition that is required for the end effector 5 to hold the target workpiece 21 is satisfied. In the present embodiment, since the robot controller 1 performs processing to detect the gripping point in step S36, whether or not one or more gripping points have been detected for the target workpiece 21 is determined. That is, in the present embodiment, the holding condition required for the end effector 5 to hold the target workpiece 21 is a condition that one or more gripping points are detected for the target workpiece 21.

In the case where the result of step S37 is YES, that is, in the case where the holding condition is satisfied, in step S38, the robot controller 1 moves the two fingers 51 of the end effector 5 in an opening direction or a closing direction on the basis of the information of the opening degree included in the gripping point, moves the robot arm 4 on the basis of the information of the position and posture included in the gripping point, then causes the end effector 5 to perform the holding operation, and thus causes the robot 7 to hold the target workpiece 21. Next, in step S39, the robot controller 1 controls the robot 7 to take out the held target workpiece 21 from the workpiece storage portion 6.

As a result of repeatedly performing the control cycle from step S35 to step S39, the workpiece 20 stored in the workpiece storage portion 6 is taken out from the workpiece storage portion 6, and thus the number of workpieces 20 in the workpiece storage portion 6 decreases. Then, depending on the interference condition of the robot 7 and the like, there is a case where the gripping point is no longer detected in step S36. For example, the gripping point is not detected for a workpiece 20 present at an end of the inner bottom surface 61 of the workpiece storage portion 6 because there is a possibility that the robot 7 interferes with the inner wall surface 62 of the workpiece storage portion 6. In the case where the result of step S37 is NO, that is, in the case where the holding condition is not satisfied, the robot controller 1 proceeds to processing of step S40.

In step S40, the robot controller 1 performs workpiece moving processing to move the target workpiece 21 in the workpiece storage portion 6 by the end effector 5 and change the placement state of the target workpiece 21 in the workpiece storage portion 6. The control operation illustrated in FIG. 4 is repeated until the workpiece 20 is no longer detected in the workpiece storage portion 6.

### Summary of Workpiece Moving Processing

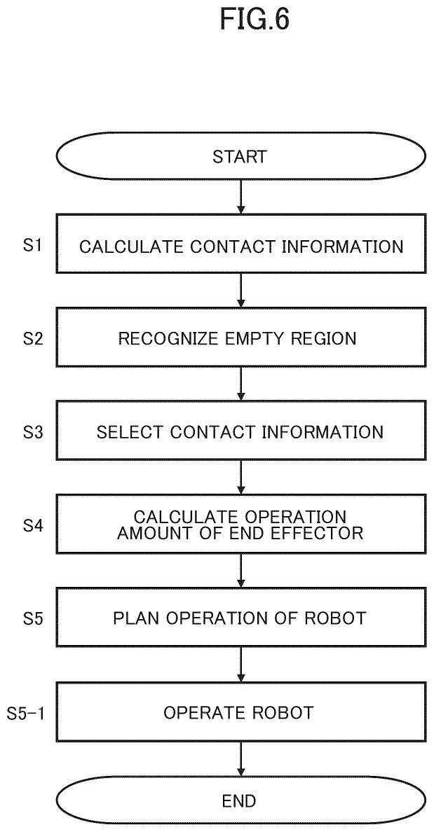

The workpiece moving processing of step S40 illustrated in FIG. 4 will be described in detail below. FIG. 6 is a control flowchart of the workpiece moving processing according to the first embodiment.

In step S1, the contact information recognition portion 10 calculates one or more pieces of contact information from the detection information obtained from the sensor 3. The contact information is control information used for controlling the robot 7.

The contact information includes information of the position and posture in which the end effector 5 can come into contact with the workpiece 21 and information of an external force vector applied to the target workpiece 21. The position and posture in which the end effector 5 can come into contact with the target workpiece 21 is a position and posture in which the end effector 5 can come into contact with the target workpiece 21 without interfering with the workpiece storage portion 6 or the other workpieces 20.

The external force vector is expressed as a three-dimensional vector of (x, y, z). The specific definition of the vector and the recognition processing method will be described later. To be noted, the contact information can be calculated for not only the workpiece 20 present at an end of the inner bottom surface 61 of the workpiece storage portion 6 illustrated in FIG. 1B, but also any other workpiece 20 inside the workpiece storage portion 6 as long as the workpiece 20 serves as the target workpiece 21.

Next, in step S2, the environment recognition portion 11 recognizes, by using the detection information obtained from the sensor 3, an empty region on the inner bottom surface 61 of the workpiece storage portion 6 to which the target workpiece 21 is movable, and thus obtains information of the empty region. The empty region is a partial region of the inner bottom surface 61 in which the inner bottom surface 61 of the workpiece storage portion 6 is exposed through the one or more workpieces 20. The information of the empty region is stored in the RAM 102 or the HDD 103. The processing of step S2 is an example of information processing.

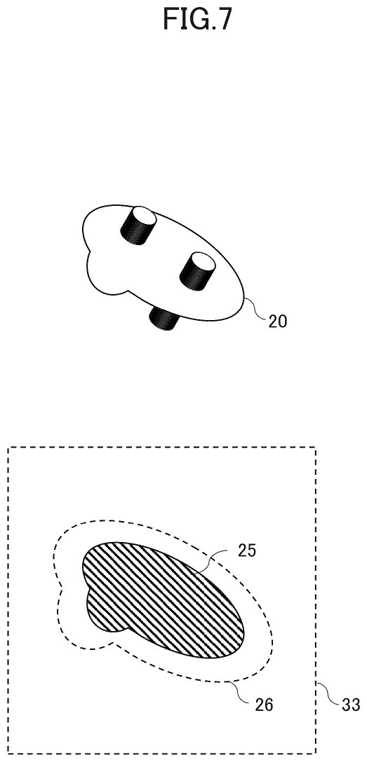

FIG. 7 is a schematic diagram for describing an empty region 33 according to the first embodiment. To be noted, the empty region 33 is obtained by computer simulation using a virtual model of the workpiece 20. A projected region (orthogonal projection) having the largest area obtained by projecting the workpiece 20 onto the inner bottom surface 61 of the workpiece storage portion 6 in a direction from the sensor 3 toward the inner bottom surface 61 of the workpiece storage portion 6 will be referred to as a workpiece region 25. The direction from the sensor 3 toward the inner bottom surface 61 of the workpiece storage portion 6 is, for example, a direction orthogonal to the inner bottom surface 61. The workpiece region 25 has an area equal to or larger than a projected region obtained by projecting the target workpiece 21 onto the inner bottom surface 61 of the workpiece storage portion 6. In the present embodiment, the empty region 33 is a region larger than the workpiece region 25. The environment recognition portion 11 defines a region obtained by extending the workpiece region 25 outward by a predetermined amount as a minimum empty region 26. The predetermined amount from the workpiece region 25 can be the thickness of a distal end portion of the finger of the end effector 5. The empty region 33 is a region larger than the minimum empty region 26. The specific method for recognizing the empty region 33 will be described later. To be noted, the workpiece region 25 may be defined as a projected region obtained by projecting the target workpiece 21 onto the inner bottom surface 61 of the workpiece storage portion 6.

To be noted, although a case where step S1 is performed first among steps S1 and S2 has been described as an example, the configuration is not limited to this, and step S2 may be performed first or steps S1 and S2 may be performed simultaneously. By performing steps S1 and S2 simultaneously, the execution time of picking per cycle can be shortened, and the production efficiency of the product is improved.

In step S3, the operation planning portion 12 selects contact information to be used for processing of step S5-1 to operate the target workpiece 21 toward the empty region 33 obtained in step S2 from the one or more pieces of contact information obtained in step S1. The method for selecting the contact information will be described later.

In step S4, the operation planning portion 12 calculates the operation amount of the end effector 5 on the basis of the contact information selected in step S3 and the information of the center position of the empty region 33. The method for calculating the operation amount will be described later.

In step S5, the operation planning portion 12 plans the operation of the robot 7 on the basis of the contact information selected in step S3 and the operation amount calculated in step S4. The method for planning the operation of the robot 7 will be described later.

The planned operation is transmitted to the controller 13. In step S5-1, the controller 13 converts the planned operation into a robot command value, and transmits the robot command value to the robot 7. The robot 7 operates in accordance with the robot command value. The controller 13 controls the robot 7 to bring the end effector 5 into contact with the target workpiece 21 and move the target workpiece 21 to the empty region 33. The processing of step S5-1 is an example of control processing.

After the target workpiece 21 is moved, the controller 13 controls the robot 7 to cause the end effector 5 to hold the target workpiece 21 in the next control cycle.

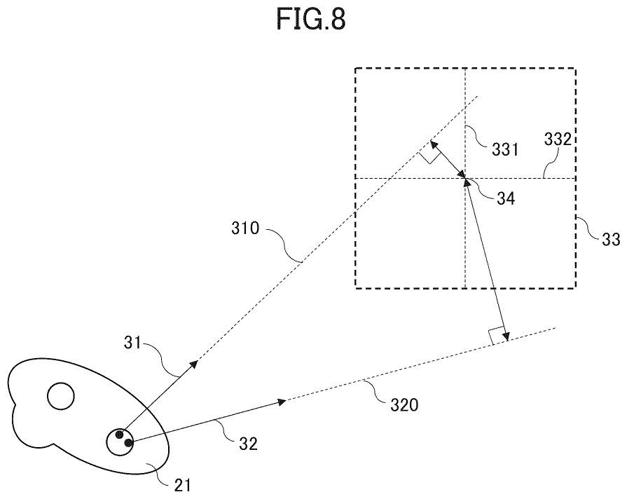

FIG. 8 is a schematic diagram for describing the method for the selection processing of the contact information executed by the operation planning portion 12 according to the first embodiment. It is assumed that in step S1 of FIG. 6, the contact information recognition portion 10 has recognized two pieces of contact information 31 and 32 for the target workpiece 21. In addition, it is assumed that in step S2 of FIG. 6, the environment recognition portion 11 has recognized the empty region 33 from the detection information (image information) obtained from the sensor 3.

The pieces of contact information 31 and 32 each include information of an external force vector applied to the target workpiece 21. The arrow in FIG. 8 indicates the external force vector. A straight line 310 overlapping with the external force vector included in the contact information 31 and a straight line 320 overlapping with the external force vector included in the contact information 32 are expressed as dotted lines. In FIG. 8, a region indicated by a broken-line quadrangle is the empty region 33. In FIG. 8, a crossing point where two dotted lines 331 and 332 orthogonal to each other intersect in the empty region 33 indicates a center 34 of the empty region 33. The dotted lines 331 and 332 each pass through the center of two sides opposing each other. To be noted, the center 34 may be the center of gravity of the empty region 33. In addition, the empty region 33 illustrated in FIG. 8 has a rectangular shape, but is not limited to this shape. For example, the empty region 33 may have a circular shape.

The operation planning portion 12 calculates the minimum Euclidean distance between the straight line 310 and the center 34 and the minimum Euclidean distance between the straight line 320 and the center 34. The operation planning portion 12 selects contact information including an external force vector overlapping with a straight line of the smaller one of the two calculated minimum Euclidean distances. As a result of this, the contact information with which the target workpiece 21 can be moved to the empty region 33 is selected. In the example of FIG. 8, the contact information 31 whose minimum Euclidean distance is the smallest among the contact information 31 and 32 is selected. To be noted, contact information whose minimum Euclidean distance exceeds a threshold value may be prohibited from selection.

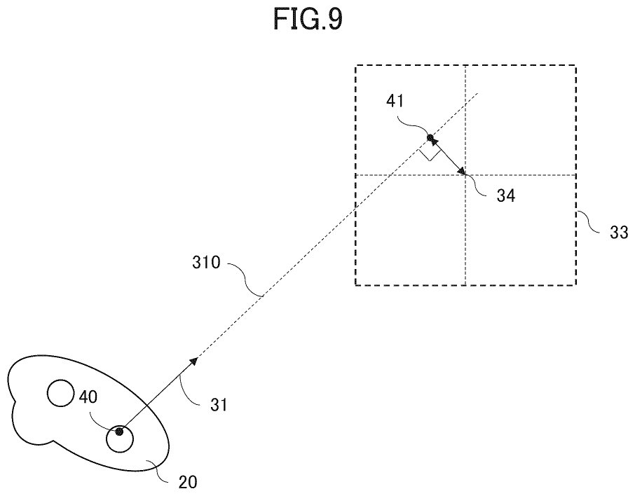

FIG. 9 is a schematic diagram for describing the calculation processing for the operation amount of the end effector 5 according to the first embodiment. The starting point of the external force vector will be referred to as an operation starting point 40. The crossing point between the straight line 310 and a perpendicular line extending from the center 34 of the empty region 33 to the straight line 310 will be referred to as a crossing point 41.

The operation planning portion 12 calculates the operation amount of the end effector 5 by using the Euclidean distance from the operation starting point 40 to the crossing point 41 of the external force vector included in the contact information 31 selected in step S3. In the case of moving the target workpiece 21, the robot 7 is controlled such that the end effector 5 moves linearly. In this case, the Euclidean distance from the operation starting point 40 to the crossing point 41 is the operation amount of the end effector 5.

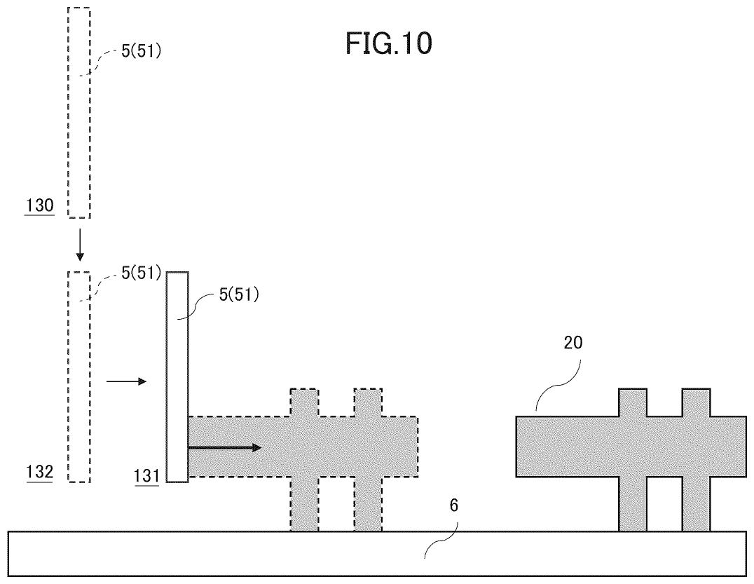

FIG. 10 is an explanatory diagram of the operation of the end effector 5 realized by the operation plan of the first embodiment. In step S5-1, the controller 13 moves the end effector 5 in an entrance direction from a position and posture 130 where approach to the target workpiece 21 in the workpiece storage portion 6 is started. The controller 13 moves the end effector 5 in a predetermined direction (operation direction) from a position and posture 132 that is a position and posture close to the target workpiece 21 to which the end effector 5 has been moved, and thus brings the end effector 5 into contact with the target workpiece 21. The position and posture of the end effector 5 in contact with the target workpiece 21 will be referred to as a position and posture 131. The controller 13 brings the finger 51 of the end effector 5 into contact with the target workpiece 21 to apply an external force in the predetermined direction (operation direction), and controls the robot arm 4 to move the target workpiece 21 in the predetermined direction (operation direction). That is, the controller 13 controls the robot arm 4 such that the end effector 5 moves linearly. At this time, the controller 13 controls the robot arm 4 such that a constant posture of the end effector 5 is maintained. The predetermined direction (operation direction) is the direction of the external force vector, that is, the direction of the external force acting on the target workpiece 21. To be noted, the postures of the positions and postures 130, 131, and 132 in FIG. 10 are the same as each other. When the end effector 5 comes into contact with a side portion of the target workpiece 21, an external force is applied to the target workpiece 21 from the end effector 5 in the operation direction of the end effector 5, and the target workpiece 21 moves in the operation direction of the end effector 5 by being pressed in the operation direction of the end effector 5. In this case, the end effector 5 slides the target workpiece 21 without holding the target workpiece 21.

In the description below, the position and posture 130 may be referred to as an approach position and posture 130, the position and posture 132 may be referred to as an entrance position and posture 132, and the position and posture 131 may be referred to as a contact position and posture 131.

In addition, the position in the position and posture 130 may be referred to as an approach position, and the posture in the position and posture 130 may be expressed as an approach posture. The position in the position and posture 132 may be referred to as an entrance position, and the posture in the position and posture 132 may be expressed as an entrance posture. The position in the position and posture 131 may be referred to as a contact position, and the posture in the position and posture 131 may be expressed as a contact posture. The approach position is an example of a first position, the entrance position is an example of a second position, and the contact position is an example of a third position.

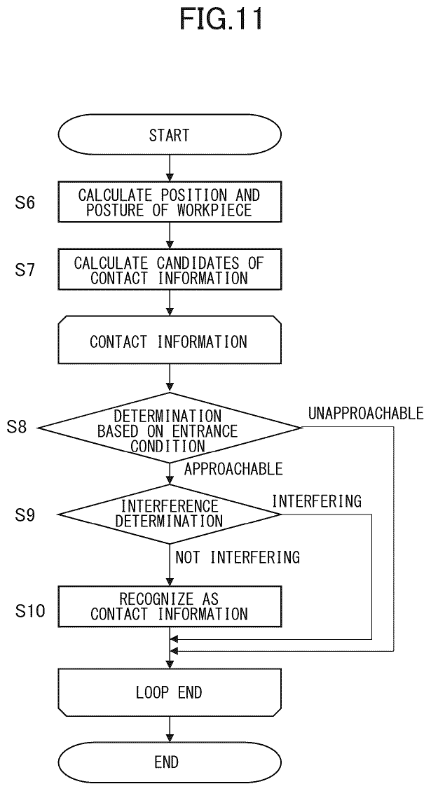

FIG. 11 is a flowchart of the calculation processing (processing of step S1) for the contact information according to the first embodiment. First, in step S6, the contact information recognition portion 10 calculates the position and posture of the target workpiece 21.

In the first embodiment, the contact information recognition portion 10 obtains, from the sensor 3, an RGBD image in which the target workpiece 21 imaged by the sensor 3 is captured as the detection information. The contact information recognition portion 10 performs matching processing on the RGBD image by using a three-dimensional model of the workpiece 20, and calculates the position and posture of the target workpiece 21 based on the sensor coordinate system of the sensor 3.

To be noted, the means to calculate the position and posture of the target workpiece 21 is not limited to this. For example, as an alternative, the contact information recognition portion 10 may calculate the position and posture of the target workpiece 21 by obtaining a point cloud data of the target workpiece 21 by using the sensor 3 and performing fitting processing by using the three-dimensional model of the workpiece 20. For the fitting processing, an existing algorithm such as iterative closest point (ICP) can be used. In addition, as another alternative, the contact information recognition portion 10 may obtain the position and posture of the target workpiece 21 by machine learning by using a captured image obtained from the sensor 3.

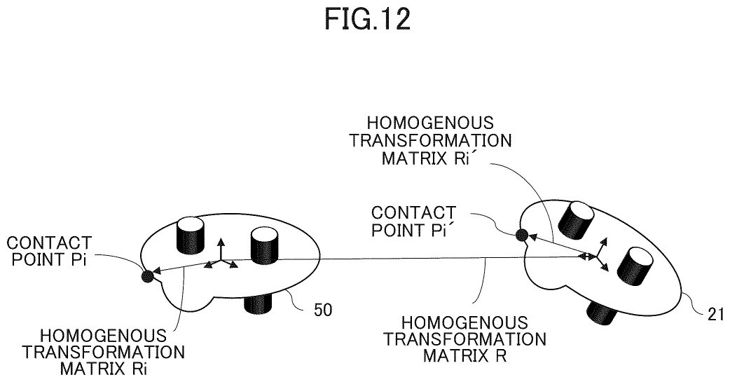

Next, in step S7, the contact information recognition portion 10 calculates candidates of the contact information. FIG. 12 is a concept diagram for describing the calculation method for candidates of the contact information according to the first embodiment. The target workpiece 21 is a workpiece serving as a holding target detected by the sensor 3, and a case where the contact information recognition portion 10 calculates candidates of the contact information of the target workpiece 21 will be described.

First, as preparation for calculating the candidates of the contact information of the target workpiece 21, a contact point Pi and the position and posture of the contact point Pi based on the workpiece coordinate system of a reference workpiece 50 are set for the reference workpiece 50. The position and posture of the reference workpiece 50 based on the sensor coordinate system may be arbitrarily set. In addition, the workpiece 50 is a workpiece of the same shape and size as the workpiece 20. In addition, the workpiece 50 may be a three-dimensional model of the workpiece 20.

The contact point Pi is associated with one or more candidates of the contact information. Here, in some cases, a plurality of candidates of the contact information are associated with one contact point. Therefore, the contact point Pi is given the affix i such that which candidate of the contact information of the same point the contact point Pi corresponds to can be understood. A 4×4 homogenous transformation matrix in which a position information vector and a rotation matrix indicating the posture are arranged will be denoted by Ri. The method for setting the candidates of the contact information will be described later.

The position and posture of the target workpiece 21 based on the sensor coordinate system has been already calculated in step S6. Therefore, the homogenous transformation matrix R for converting the position and posture of the reference workpiece 50 into the position and posture of the target workpiece 21 can be calculated. Therefore, a position and posture Ri′ of a contact point Pi′ of the target workpiece 21 based on the workpiece coordinate system of the target workpiece 21 is obtained by matrix calculation of R×Pi. Since a plurality of candidates of the contact information are associated with the reference workpiece 50 in advance, all the candidates of the contact information of the target workpiece 21 are calculated by the method described above.

The contact information recognition portion 10 calculates the position and posture based on the workpiece coordinate system of the candidates of the contact information associated with the target workpiece 21 by the method described above, and then calculates the reference coordinate system of the position and posture of the calculated contact information candidates from the workpiece coordinate system into the sensor coordinate system. For the conversion, Ri′ described above may be multiplied by the homogenous transformation matrix indicating the position and posture of the target workpiece 21 calculated in step S6 from the left side. Next, the contact information recognition portion 10 converts the position and posture of candidates of the contact information based on the sensor coordinate system into the position and posture of the candidates of the contact information based on the coordinate system of the end effector 5. The transformation matrix from the sensor coordinate system into the end effector coordinate system can be obtained by a known method. For example, a matrix to mutually convert the posture between the sensor coordinate system and the end effector coordinate system may be obtained by calibrating the internal parameters and external parameters of the sensor 3.

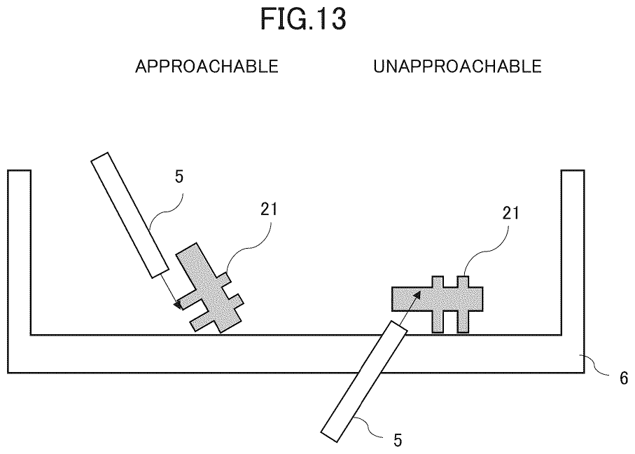

Next, in step S8, the contact information recognition portion 10 determines whether or not an entrance condition is satisfied, for all the recognized candidates of the contact information. FIG. 13 is an explanatory diagram of the processing to determine whether or not the entrance condition according to the first embodiment is satisfied. Here, the end effector 5 of the robot 7 illustrated in FIG. 1A can approach the target workpiece 21 only from the opening side (upper side) of the workpiece storage portion 6. The entrance condition is, for example, a condition that the distal end portion of the end effector 5 is not directed toward the opening side of the workpiece storage portion 6 when the robot is moved to the posture (approach posture) of the position and posture 130 illustrated in FIG. 10.

Therefore, in step S8, the contact information recognition portion 10 excludes candidates of contact information in which the distal end portion of the end effector 5 is directed toward the opening of the workpiece storage portion 6 in the approach posture based on the end effector coordinate system calculated in step S7 of FIG. 11, by regarding that the candidates do not satisfy the entrance condition, that is, are unapproachable as in the example on the right side of FIG. 13.

Next, in step S9, the contact information recognition portion 10 performs interference determination. The interference determination is performed to determine whether or not the end effector 5 and the workpiece storage portion 6 interfere with each other, and whether or not the end effector 5 interferes with the workpieces 22 other than the target workpiece 21 in the workpiece storage portion 6.

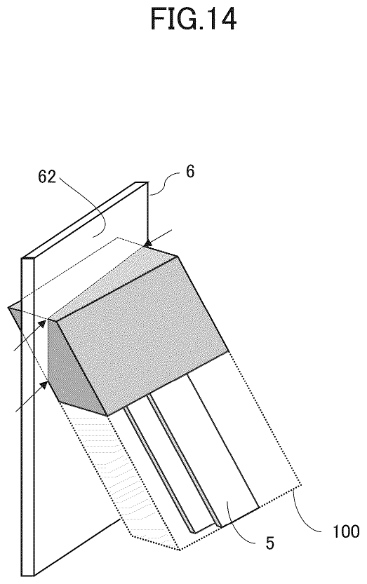

FIG. 14 is a schematic diagram for describing the interference determination between the workpiece storage portion 6 and the end effector 5 according to the first embodiment. A region 100 illustrated in FIG. 14 is a three-dimensional region of a rectangular parallelepiped shape having the smallest size among rectangular parallelepiped regions inscribing the end effector 5. The region 100 is disposed in the position and posture 130 that is included in the candidates of the contact information and that is approachable. The workpiece storage portion 6 is positioned in advance, and the positions of all the inner wall surfaces 62 of the workpiece storage portion 6 are known to the robot controller 1. At this time, the interference determination can be performed by performing intersection determination to determine whether or not each side of the region 100 intersects with the inner wall surface 62 of the workpiece storage portion 6. In the case where at least one side of the region 100 intersects with the inner wall surface 62 of the workpiece storage portion 6, the determination result is “interfering”. In the case where no side of the region 100 intersects with the inner wall surface 62 of the workpiece storage portion 6, the determination result is “not interfering”.

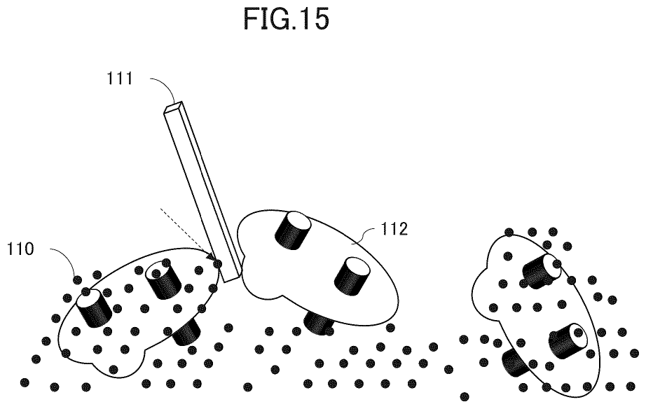

FIG. 15 is a schematic diagram for describing the interference determination between the end effector 5 and workpieces in the workpiece storage portion 6 according to the first embodiment. The space information in the workpiece storage portion 6 can be obtained as point cloud information from the sensor 3.

The region of the distal end portion, that is, the fingers 51 of the end effector 5 disposed in the approach position and posture 130 obtained from the contact information will be referred to as a region 111. The contact information recognition portion 10 gives a determination result of “not interfering” in the case where no point of the point cloud 110 is present in the region 111. The contact information recognition portion 10 gives a determination result of “interfering” in the case where at least one point of the point cloud is present in the region 111.

To be noted, the point cloud of all the detected points include a point cloud 112 of the target workpiece 21. The point cloud 112 of the target workpiece 21 is a contact target, and therefore needs to be excluded from targets of the interference determination. Therefore, the contact information recognition portion 10 excludes a point cloud whose distance from the coordinate origin of the target workpiece 21 is equal to or less than a threshold value from the point cloud 110 as the point cloud 112 of the target workpiece 21. The threshold value is set to the radius of a sphere circumscribing the target workpiece 21. To be noted, the threshold value may be arbitrarily set by the user. In FIG. 15, a point indicated by a broken line arrow in the point cloud 110 is included in the region 111, and is therefore determined as “interfering”.

In step S10, the contact information recognition portion 10 recognizes a candidate of contact information of interest as the contact information in the case where the candidate is determined as “possible to enter” in step S8 and “not interfering” in step S9. To be noted, the recognition method described above is applicable to not only the workpiece 20 present at an end of the workpiece storage portion 6 but also arbitrary workpieces that are present in the workpiece storage portion 6 and whose position and posture can be detected.

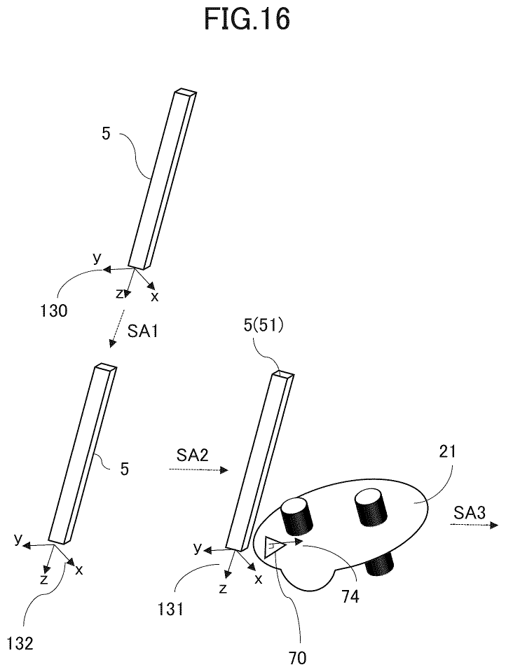

Next, the method for setting candidates of the contact information will be described. FIG. 16 is a schematic diagram for describing the method for setting the candidates of contact information according to the first embodiment. The contact information at least includes information of a contact position of the end effector 5 that is based on the workpiece coordinate system of the target workpiece 21 and where the end effector 5 can come into contact with the target workpiece 21. In the present embodiment, the contact information includes information of the contact position and posture 131 of the end effector 5 that is based on the workpiece coordinate system of the target workpiece 21 and where the end effector 5 can come into contact with the target workpiece 21, and information of an external force vector applied to the target workpiece 21. The external force vector is a vector of an external force applied to the target workpiece 21 to move the target workpiece 21 to the empty region without rotating the target workpiece 21.

In the present embodiment, to set the candidates of contact information, the position and posture (approach position and posture) 130 where the approach of the end effector 5 to the target workpiece 21 is started, the position and posture (entrance position and posture) 132 where the end effector 5 opposes a contact portion of the target workpiece 21 in a predetermined direction as a result of the approach and the end effector 5 enters a position in the vicinity of the contact portion of the target workpiece 21, and the position and posture (contact position and posture) 131 where the end effector 5 comes into contact with the target workpiece 21 are defined on the basis of the workpiece coordinate system of the target workpiece 21. Among these positions and postures 130, 132, and 131, the contact position and posture 130 is set as a position and posture where contact is possible in the contact information.

The entrance position and posture 132 and the approach position and posture 130 are obtained from the contact position and posture 131 by a method described below. In addition, an opposite vector 74 of a direction opposite to a normal vector of a minute flat surface 70 on the target workpiece 21 that the end effector 5 comes into contact with is set as information of the external force vector included in the contact information.

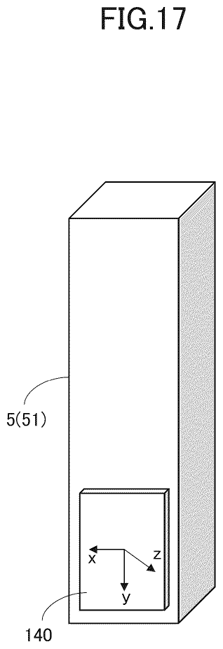

FIG. 17 is an explanatory diagram of the end effector 5 according to the first embodiment. The finger 51 of the end effector 5 includes a minute surface 140 that comes into contact with the target workpiece 21. A coordinate system including the center of the minute surface 140 as the origin is defined for the minute surface 140. To be noted, the coordinate system of the minute surface 140 and the end effector coordinate system of the end effector 5 are different from each other.

Next, a setting method for the candidates of the contact information will be described in detail. The setting of the candidates of the contact information is performed by, for example, three-dimensional simulation using a three-dimensional model. The contact information recognition portion 10 stores a three-dimensional model (information) of the end effector 5 and a three-dimensional model (information) of the workpiece 20 in advance.

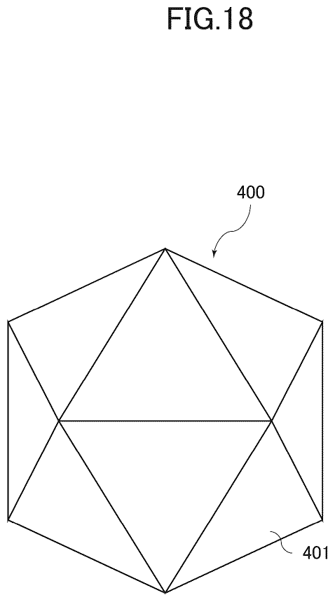

The three-dimensional model of the end effector 5 and the three-dimensional model of the workpiece 20 are expressed by mesh. FIG. 18 is an explanatory diagram of a three-dimensional model 400 according to the first embodiment. As illustrated in FIG. 18, the three-dimensional model 400 is a collection of a plurality of flat surfaces 401. The flat surface 401 is, for example, a triangular flat surface. The minute flat surface 70 of the target workpiece 21 that the end effector 5 comes into contact with can be considered as a flat surface of the three-dimensional model of the target workpiece 21 expressed by mesh.

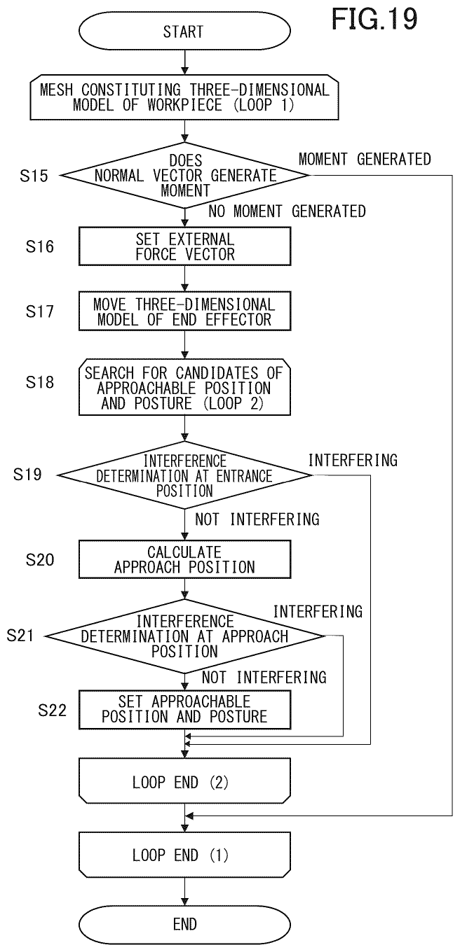

FIG. 19 is a flowchart illustrating processing of setting the candidates of the contact information according to the first embodiment. First, the contact information recognition portion 10 arbitrarily selects one flat surface from the mesh constituting the three-dimensional model of the target workpiece 21. For example, in the case where a three-dimensional model 400 illustrated in FIG. 18 is the three-dimensional model of the target workpiece 21 serving as a holding target, arbitrary one of triangular flat surfaces constituting the three-dimensional model 400 is selected. The selection method and the selection order are not limited.

In step S15, the contact information recognition portion 10 determines whether or not a normal vector 73 of the triangular mesh generates a moment on the target workpiece 21.

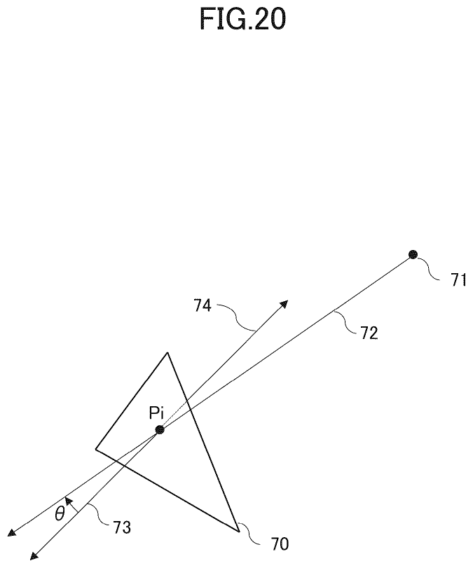

FIG. 20 is a schematic diagram for describing a method for determining whether or not the moment is generated according to the first embodiment. In the case where the starting point of the normal vector 73 of the triangular mesh is the contact point Pi, smaller one (minor angle) of angles (major angle and minor angle) formed between the normal vector 73 and a vector 72 extending from the center of gravity 71 of the target workpiece 21 through the contact point Pi is denoted by θ.

In the case where the angle θ is smaller than a threshold value θt, the contact information recognition portion 10 gives a determination result of “no moment generated”. In the case where the angle θ is equal to or larger than the threshold value θt, the contact information recognition portion 10 gives a determination result of “moment generated”, and performs determination on next mesh. The threshold value θt may be set within a range of ±90°, but can be set within a range of ±1°. This is because in the case where the absolute value of the threshold value is too large, there is a possibility that the target workpiece 21 does not move as intended due to the moment generated when the end effector 5 applies an external force to the target workpiece 21.

In the case where it is determined that no moment is generated in step S15, the contact information recognition portion 10 proceeds to processing of step S16.

In step S16, the contact information recognition portion 10 sets the opposite vector 74 of the normal vector 73 as an external force vector in the contact information. In this case, the contact information recognition portion 10 performs the setting such that the origin of the minute surface 140 of the end effector 5 overlaps with the contact point Pi.

In step S17, the contact information recognition portion 10 moves the three-dimensional model of the end effector 5 by a predetermined distance in the direction of the normal vector 73.

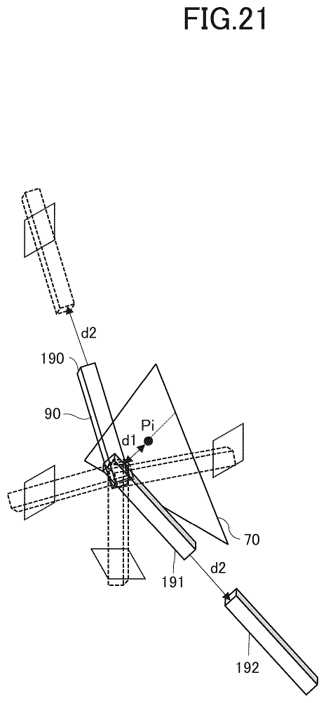

FIG. 21 is a schematic diagram for describing the processing for setting the candidates of the contact information according to the first embodiment. As illustrated in FIG. 21, the contact information recognition portion 10 moves a three-dimensional model 90 of the end effector 5 by a distance d1 from the contact point Pi in the direction of the normal vector 73.

In step S18, the contact information recognition portion 10 searches for candidates of the entrance position and posture. Specifically, the contact information recognition portion 10 rotates the three-dimensional model 90 about the center of the minute surface 140 illustrated in FIG. 17 at the position to which the three-dimensional model 90 has been moved in step S17, and searches for a state that the three-dimensional model 90 can take as the entrance position and posture.

In this case, if the three-dimensional model 90 is rotated continuously, the positions and postures to be subjected to the interference determination that will be described later increases enormously and the calculation time diverges, and therefore in the first embodiment, the contact information recognition portion 10 performs the search by quantizing the rotational angle of the three-dimensional model 90.

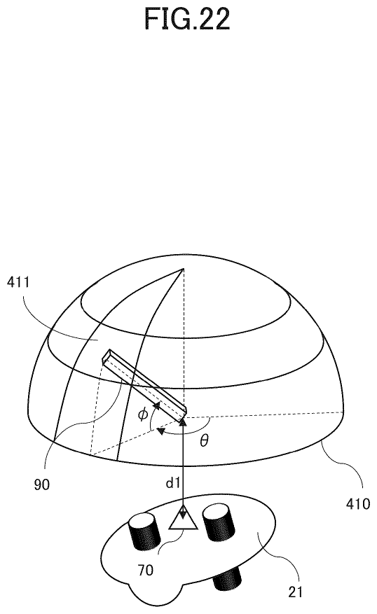

FIG. 22 is a schematic diagram for describing the rotation of the three-dimensional model 90 of the end effector 5 according to the first embodiment. As illustrated in FIG. 22, the contact information recognition portion 10 sets a spherical surface 410 centered on the minute surface 140, divides the spherical surface 410 by a certain latitude and a certain longitude, and defines a curved surface 411 enclosed by two adjacent latitude lines and two adjacent longitude lines. At this time, the angle (θ, φ) of a straight line passing through the center of the curved surface 411 is set as a search angle. The latitude lines and the longitude lines may be set at an arbitrary pitch with which calculation can be performed in a realistic time by the calculation resource of the user. However, the quantization method is not limited to this.

In step S19, the contact information recognition portion 10 performs interference determination on the position and posture of the rotated three-dimensional model 90. A known method such as the ray casting method can be used for the interference determination.

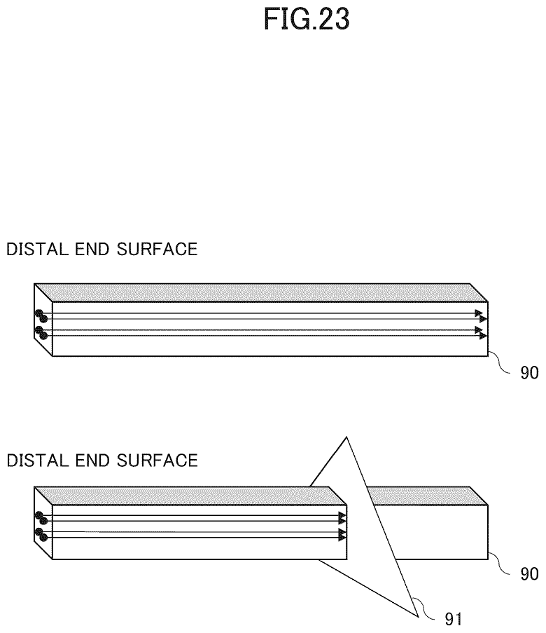

FIG. 23 is a schematic diagram for describing the interference determination according to the first embodiment. In the ray casting method, a light beam is radiated orthogonally onto from a mesh of a 3D model, and when the light beam passes through a mesh of an object model, the position of the crossing point with the mesh of the object model and the distance from the mesh of the 3D model to the crossing point can be obtained. In the first embodiment, the light beam is radiated from the distal end surface of the three-dimensional model 90 indicating the finger of the end effector 5 to the root of the three-dimensional model 90. In the case where the three-dimensional model 90 is interfering with another object model, a mesh 91 constituting the interfering object model intersects with the three-dimensional model 90. Therefore, the crossing point is obtained by the ray casting method. The position and posture of the three-dimensional model 90 determined as “not interfering” in the interference determination is set as the entrance position and posture.

In FIG. 21, it is indicated that there is no interference in a position and posture 190 and a position and posture 191. In the case where the entrance position and posture is confirmed, a position and posture that is offset therefrom by the distance d1 in a direction opposite to the normal vector 73 is set as the contact position and posture.

In step S20, the contact information recognition portion 10 moves the three-dimensional model 90 of the end effector 5 in a direction toward the root of the end effector 5 by an arbitrary distance d2 as illustrated in FIG. 21, for the positions and postures 190 and 191 determined as “not interfering” in step S19. The positions and postures of the three-dimensional model 90 after the movement are set as candidates of the approach position and posture.

Next, in step S21, the contact information recognition portion 10 performs the interference determination of the candidates of the approach position and posture by a method similar to that of the entrance position and posture. In the case where the result of determination in step S21 is “not interfering”, the contact information recognition portion 10 proceeds to step S22. In step S22, the contact information recognition portion 10 sets the candidate of the approach position and posture as a position and posture to which approach is possible. In FIG. 21, the position and posture 192 is an approachable position and posture, and is set as a candidate of the contact information.

By the method described above, candidates of the contact information including information of the position and posture that the end effector 5 can approach and information of the external force vector are set. To be noted, the method for setting the candidates of the contact information is not limited to the example described above.

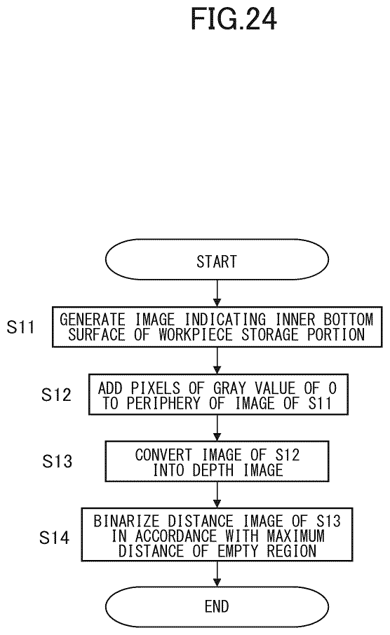

Next, processing to recognize the empty region in step S2 of FIG. 6 will be described in detail. FIG. 24 is a flowchart of processing (processing of step S2) to recognize the empty region according to the first embodiment.

In step S11, the environment recognition portion 11 generates an image indicating the state of the inner bottom surface 61 of the workpiece storage portion 6. The space information in the workpiece storage portion 6 can be obtained as point cloud information by the sensor 3. The environment recognition portion 11 regards positions of point clouds whose Z coordinate is equal to or lower than a certain position among the obtained point clouds as belonging to the inner bottom surface 61 of the workpiece storage portion 6. By this processing, the environment recognition portion 11 generates an image indicating the arrangement state of the workpiece 20 on the inner bottom surface 61 of the workpiece storage portion 6.

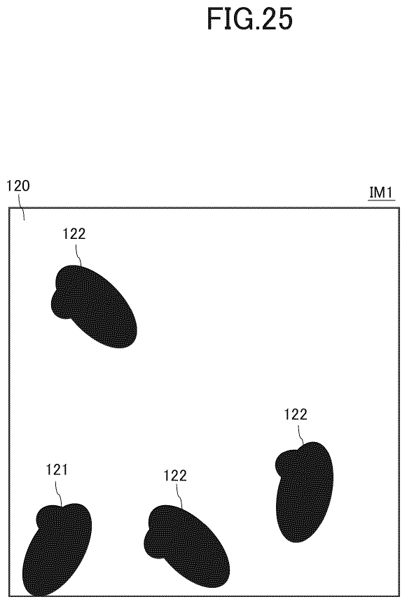

FIG. 25 is a schematic diagram of an image IM1 generated by the environment recognition portion 11 according to the first embodiment. In step S11, the environment recognition portion 11 generates the image IM1 illustrated in FIG. 25. In FIG. 25, an inner bottom surface 120 corresponding to the inner bottom surface 61 of the workpiece storage portion 6, a workpiece 121 corresponding to the target workpiece 21 serving as a holding target (movement target), and workpieces 122 corresponding to the other workpieces 22 are drawn. The image IM1 is an 8-bit binary image in which the regions where the workpieces 121 and 122 are present are indicated by a gray value of 0, and the exposed portion of the inner bottom surface 120 is indicated by a gray value of 255. To be noted, the bit depth of the image IM1 may be an arbitrary value, and the gray value of the exposed portion may be of an arbitrary value as long as the value is a non-zero positive value. The sizes of the inner bottom surface 120 and the workpieces 121 and 122 in the image may be any size as long as the relativity therebetween is maintained. To be noted, it has to be possible to convert the position of each pixel into a position based on the sensor coordinate system.

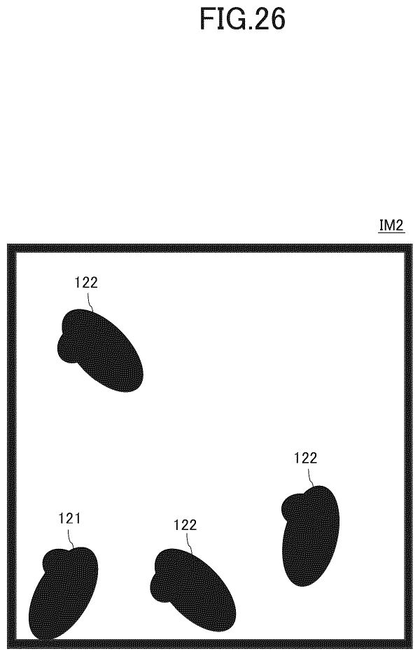

FIG. 26 is a schematic view of an image IM2 generated by the environment recognition portion 11 according to the first embodiment. In step S12, the environment recognition portion 11 generates the image IM2 to which pixels of a gray value of 0 are added along the outer edge portion of the image IM1 to add information of the wall of the workpiece storage portion 6 to the image IM1 generated in step S11. The number of pixels added in the thickness direction of the wall may be one or more.

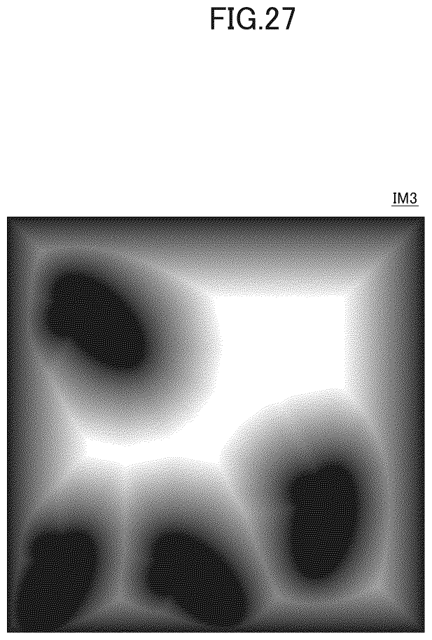

FIG. 27 is a schematic view of a distance image IM3 according to the first embodiment. In step S13, the environment recognition portion 11 calculates the distance image IM3 from the image IM2 generated in step S12. Specifically, the environment recognition portion 11 sets each of the plurality of pixels of the image IM2 as a pixel of interest, calculates the Euclidean distance between the pixel of interest and a pixel of a gray value of 0 closest to the pixel of interest, changes the gray value of the pixel of interest to a value corresponding to the Euclidean distance, and thus calculates the distance image IM3.

As the conversion method from the image IM2 to the distance image IM3, calculation can be performed by using a technique disclosed in “C.R. Maurer; Rensheng Qi; V. Raghavan, A linear time algorithm for computing exact Euclidean distance transforms of binary images in arbitrary dimensions”.

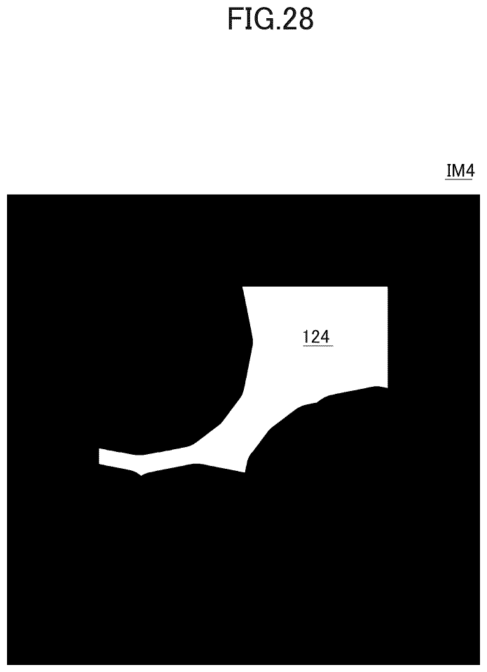

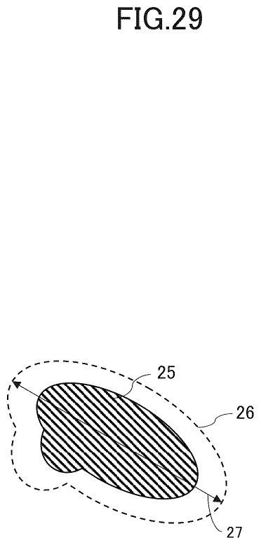

FIG. 28 is a schematic view of a binary image IM4 according to the first embodiment. In step S14, the environment recognition portion 11 generates the binary image IM4 obtained by binarizing the distance image IM3 obtained by conversion in step S13. The threshold value for the binarization is set to, for example, the maximum distance (in terms of pixels) of the empty region to be searched for. As a result of this, only a region where the distance from the workpiece is equal to or larger than the distance is extracted. FIG. 29 is an explanatory diagram illustrating the maximum distance 27 of the minimum empty region 26 illustrated in FIG. 7 according to the first embodiment. The threshold value is set to, for example, the maximum distance 27.

In FIG. 28, a region 124 indicated by white is a region that is away from the wall of the workpiece storage portion 6 and the workpieces by a distance equal to or larger than the maximum distance 27 of the minimum empty region 26. Therefore, the target workpiece 21 can be moved to the empty region 33 by operating the end effector 5 to a position corresponding to an arbitrary pixel in the region 124. Each of the pixels constituting the region 124 serves as the center 34 of the empty region 33 obtained in step S2 of FIG. 6. To be noted, the threshold value may be an arbitrary value as long as the threshold value is equal to or larger than the maximum distance 27 of the minimum empty region 26, and a larger region where no workpiece or wall is present therearound is required in the case where the threshold value is larger.

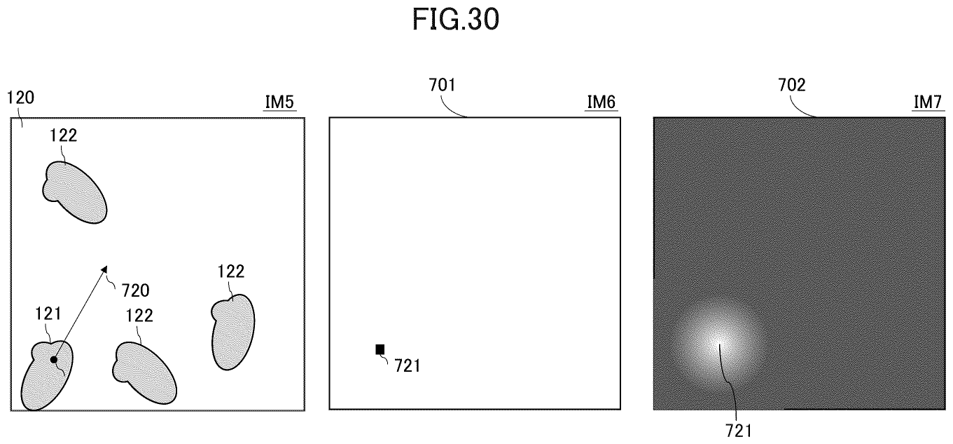

The environment recognition portion 11 selects, by a predetermined method, the empty region 33 to which the target workpiece 21 is to be moved. For example, the environment recognition portion 11 may select, from the region 124, the center 34 of the empty region 33 to which the Euclidean distance from the approach position is the smallest. A specific selection method will be described with reference to FIG. 30. IM5 in FIG. 30 indicates an external force vector 720 and a contactable position 721 of the contact information selected in the state of IM1 in FIG. 25. At this time, the environment recognition portion 11 generates an image IM6 in which the gray value of only the pixel corresponding to the contactable position 721 is 0 and which is of the same size as the image IM4 of FIG. 28. Next, IM6 is converted into IM7 by the method used when converting IM3 into IM4. Next, when IM7 is subjected to mask processing by using IM4, the Euclidean distance from each pixel of the region 124 to the contactable position 721 is obtained. The pixel of the shortest Euclidean distance in the region 124 is selected as the empty region 33.

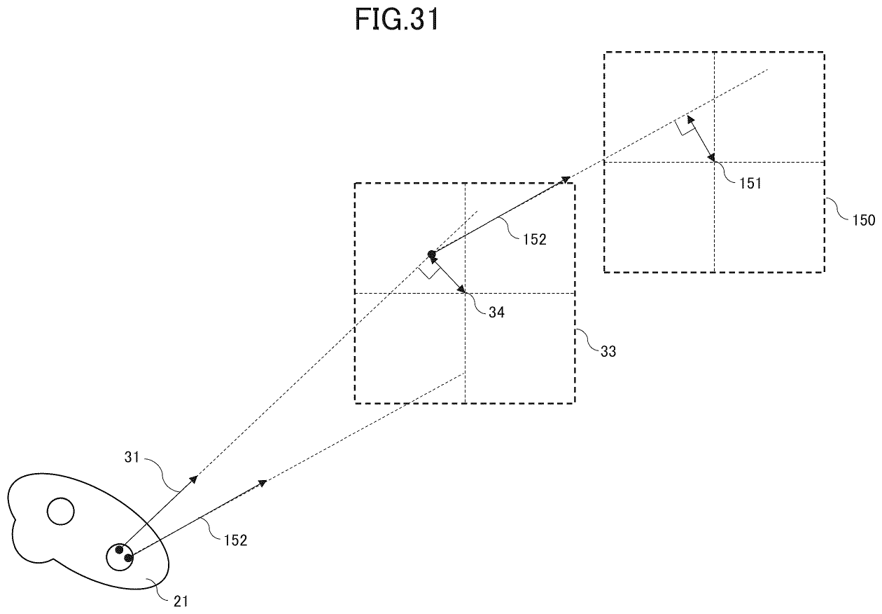

The environment recognition portion 11 may select two or more arbitrary points from the region 124. FIG. 31 is an explanatory diagram of information processing of another example according to the first embodiment. As illustrated in FIG. 31, the environment recognition portion 11 obtains, by using the detection information from the sensor 3, information of the empty region 33 as a first region, and information of an empty region 150 as a second region. The empty region 150 is also a region to which the target workpiece 21 in the workpiece storage portion 6 can be moved similarly to the empty region 33.

Regarding the information of the empty region 33, the Euclidean distance between the center 34 of the empty region 33 and the straight line overlapping with the external force vector is evaluated on the basis of the information of the external force vector applied to the target workpiece 21 included in the contact information 31. In the example of FIG. 31, the contact information 31 is selected as the contact information for moving the target workpiece 21 to the empty region 33.

Regarding the information of the empty region 150, the Euclidean distance between the external force vector and a center 151 of the empty region 150 is evaluated on the basis of a coordinate point where the straight line obtained from the information of the external force vector included in the contact information 31 and the center 34 of the empty region 33 are closest. In the example of FIG. 31, contact information 152 is selected as the contact information for moving the target workpiece 21 from the empty region 33 to the empty region 150. To be noted, the environment recognition portion 11 may recognize the empty regions 33 and 150 in different conditions. For example, when recognizing the empty region 150 serving as a destination, the environment recognition portion 11 can move the target workpiece 21 to a position away from surrounding workpieces and the wall of the workpiece storage portion 6 by increasing the threshold value for the binarization processing. That is, in the control processing of step S5-1, the controller 13 controls the robot 7 to bring the end effector 5 into contact with the target workpiece 21 to move the target workpiece 21 to the empty region 33, and then move the target workpiece 21 from the empty region 33 to the empty region 150.

Next, a specific selection method for the contact information in step S3 of FIG. 6 will be described. The operation planning portion 12 may select arbitrary one point in the region 124 indicating the candidates of the empty region obtained by the flowchart of FIG. 24, and select the contact information by the method of FIG. 8. The operation amount of the end effector in step S4 of FIG. 6 may be calculated by the method described with reference to FIG. 9 as described above.

Next, an operation planning method of the robot 7 in step S5 of FIG. 6 will be described. When the robot 7 operates such that the end effector 5 moves in accordance with the contact information selected in step S3, the end effector 5 moves to the position and posture 130 illustrated in FIG. 16. To move the end effector 5 from the position and posture 130 to the position and posture 131, the end effector 5 may be moved in the Z direction from the position and posture 130 by the distance d2 on the basis of the coordinate system of the end effector 5, and may be moved by the distance d1 in the operation direction of the end effector 5. Then, by moving the end effector 5 in the operation direction by the operation amount obtained in step S4, the target workpiece 21 can be moved. Then, in the control processing of step S5-1, the controller 13 controls the robot 7 in accordance with the contact information generated in step S5 by using the contact information. That is, the controller 13 brings the end effector 5 into contact with the target workpiece 21 such that the direction of the external force applied to the target workpiece 21 is a direction toward the empty region 33. Then, the controller 13 moves the target workpiece 21 in the operation direction of the end effector 5 by moving the end effector 5.

Specifically, as illustrated in FIG. 16, the control processing of step S5-1 includes first control processing SA1 of moving the end effector 5 to the entrance position (132) where the end effector 5 opposes the target workpiece 21 in the predetermined direction from the approach position (130), second control processing SA2 of moving the end effector 5 in the predetermined direction from the entrance position (132) to bring the end effector 5 into contact with the target workpiece 21, and third control processing SA3 of, after the end effector 5 has come into contact with the target workpiece 21, moving the end effector 5 in the predetermine direction to apply an external force to the target workpiece 21 and thus moving the target workpiece 21. The controller 13 maintains the end effector 5 in a certain posture in the first control processing SA1, the second control processing SA2, and the third control processing SA3. As a result of such operation of the robot 7, the reliability of the movement of the target workpiece 21 to the empty region 33 can be improved.

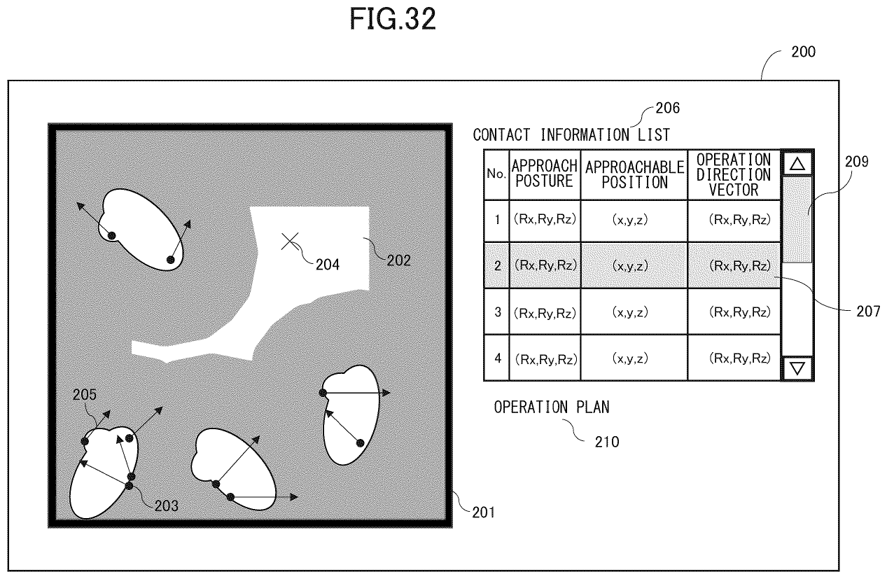

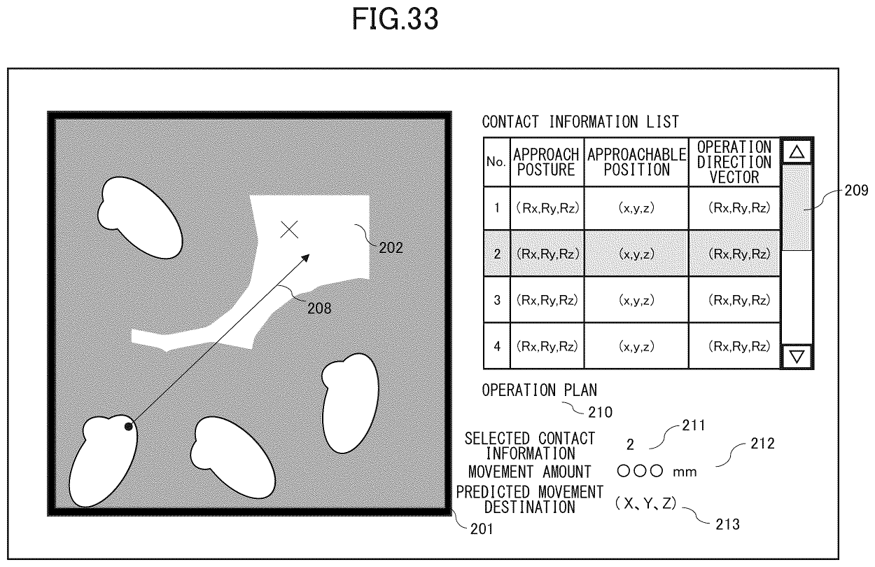

The controller 13 displays, on the display 109 of FIG. 2, an image for presenting the recognized contact information, the empty region, and operation planning result to the user. FIGS. 32 and 33 are explanatory diagrams of a graphical user interface (GUI) 200 serving as an example of a display image according to the first embodiment. The GUI 200 includes a top-view image window 201 displaying image information obtained by imaging the workpiece storage portion 6, a contact information display portion 206 that displays a list of recognized contact information, and an operation plan display portion 210.

The top-view image window 201 displays a captured image obtained by the sensor 3 used when recognizing the contact information and the environmental information. The empty region is overlaid on the captured image. A set 202 of centers of empty regions is displayed in white, and other part is displayed in gray.

In addition, the center of the empty region selected during the planning of the operation is indicated by an X mark 204. In addition, the recognized contact information is indicated by arrows 203. The data of the contact information is displayed as a list in the contact information display portion 206.

The contact information display portion 206 has a fixed size, and the user can check all the data of the contact information by scrolling a scroll bar 209. When the user clicks contact information to be focused on from the contact information display portion 206, for example, contact information 207, the color of the corresponding part of the list changes, and an arrow corresponding to the selected contact information is highlighted as in an arrow 205.

In addition, the operation planning result 208 is indicated by an arrow as illustrated in FIG. 33. The operation planning result 208 is displayed when the operation plan is generated by the operation planning portion 12. The arrow indicating the operation planning result 208 extends from the contactable position of the contact information to the position of the movement destination of the end effector 5. At this time, in an operation plan display portion 210, the serial number of the contact information used for the operation plan is displayed in a used contact information display portion 211, the movement amount of the end effector 5 is displayed in a movement amount display portion 212, and a predicted movement destination position of the target workpiece 21 is displayed in a predicted movement destination display portion 213.

By executing the method described above, in the robot system 1000 illustrated in FIG. 1A, an operation to move the target workpiece 21 serving as a holding target to a position where the inner wall surface 62 of the workpiece storage portion 6 or other workpieces are not present nearby can be planned. As a result of this, the target workpiece 21 can be held by the end effector 5, and the production efficiency of the product by the robot system 1000 can be improved. As described above, according to the first embodiment, a technique advantageous for the robot 7 to hold the workpiece 20 can be provided.

### Second Embodiment

A second embodiment will be described. In the first embodiment described above, a case where the operation of the robot 7 is planned by using one piece of contact information has been described as an example. Since the end effector 5 of FIG. 1A includes a parallel chuck including two fingers 51, the target workpiece 21 can be also moved by bringing the two finger 51 into contact with the target workpiece 21 by using two pieces of contact information. As a result of this, as compared with the case where the external force is applied to one portion, moving the target workpiece 21 without rotation can be facilitated. As a part different from the first embodiment, the setting method for the contact information in the second embodiment will be described below.

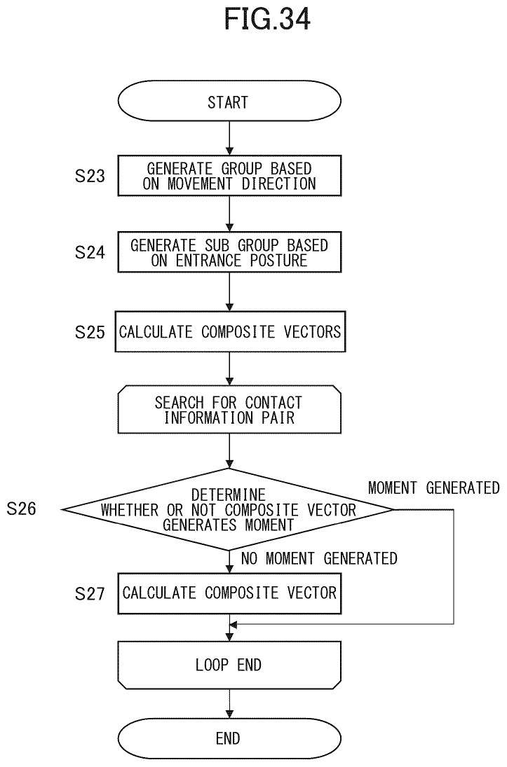

FIG. 34 is a flowchart illustrating processing to set the candidates of the contact information according to the second embodiment. In the second embodiment, the contact information recognition portion 10 executes each processing of the flowchart illustrated in FIG. 34 in addition to the flowchart illustrated in FIG. 19. In the second embodiment, the contact information recognition portion 10 generates a pair of contact information where the end effector 5 can touch the workpiece by the two fingers 51.

First, in step S23, the contact information recognition portion 10 groups set candidates of the contact information. The external force vector applied to the target workpiece 21 is quantized by the method illustrated in FIG. 22, and pieces of contact information including external force vectors belonging to the same curved surface 411 are grouped together.

Next, in step S24, the contact information recognition portion 10 classifies all the contact information in the group generated in step S23 into sub groups in accordance with the approachable postures. In this processing, pieces of contact information that are of the same posture after the quantization may be classified into the same sub group similarly to step S23.

Next, in step S25, the contact information recognition portion 10 calculates a composite vector of the external force vectors of two arbitrary pieces of contact information in the sub group. In this case, the contact information recognition portion 10 performs the composition of vectors for all combinations. To be noted, the composition of vectors is not performed in the case where the distance between two approachable positions is larger than the maximum opening amount of the two fingers 51 of the end effector 5.

Next, in step S26, the contact information recognition portion 10 checks, for all the composite vectors calculated in step S25, whether or not the composite vector generates a moment. The same checking method as in step S15 may be used.

The contact information recognition portion 10 defines two pieces of contact information corresponding to a composite vector determined as not generating a moment as a pair of contact information to be used for bringing the two fingers 51 into contact with the workpiece in step S27. To be noted, the pair of contact information is constituted by contactable positions, contactable postures, opening degree of the end effector, and the external force vectors applied to the target workpiece 21.

For the contactable postures, the quantized contactable posture of the two pieces of contact information constituting the pair may be used. For the contactable position, an average value of the contactable positions of the two pieces of contact information constituting the pair may be used. For the opening degree of the end effector, the Euclidean distance between the contactable positions of the two pieces of contact information constituting the pair may be used. For the external force vector applied to the workpiece, the composite vector of the external force vectors of the two pieces of contact information constituting the pair may be used.

Next, the recognition method for the contact information pair and the operation planning method will be described. First, the contact information is recognized by the same method as in the first embodiment. Next, from the recognized contact information, pieces with which a defined pair can be generated are selected. In this manner, the pair of contact information is recognized.

When the pair of contact information is generated, the environmental information is recognized in step S2 of the flowchart illustrated in FIG. 6. Next, in step S3, the contact information is selected. At this time, for the entrance condition of step S8 and the interference determination of step S9, the contactable position and posture of the pair of contact information are used.

Next, in step S4, the operation amount of the end effector 5 is calculated. For the calculation of the operation amount, the contactable position and posture of the pair of contact information are used. Finally, in step S5, the operation of the end effector 5 is planned.

The controller 13 controls the end effector 5 to take the contactable position and posture of the pair of contact information and open by the opening degree of the end effector 5 in the pair of contact information. In this manner, the operation can be planned similarly to the first embodiment.

### Third Embodiment

A third embodiment will be described. In the first embodiment described above, a method for moving one target workpiece 21 to the empty region has been described. In the third embodiment, an operation planning method in which one or more workpieces present in a path for moving the target workpiece 21 to the empty region are moved to an empty region not affecting the movement of the target workpiece 21 to secure a path for the target workpiece 21 to move will be described. To be noted, it is assumed that two or more workpieces 20 are still in the workpiece storage portion 6.

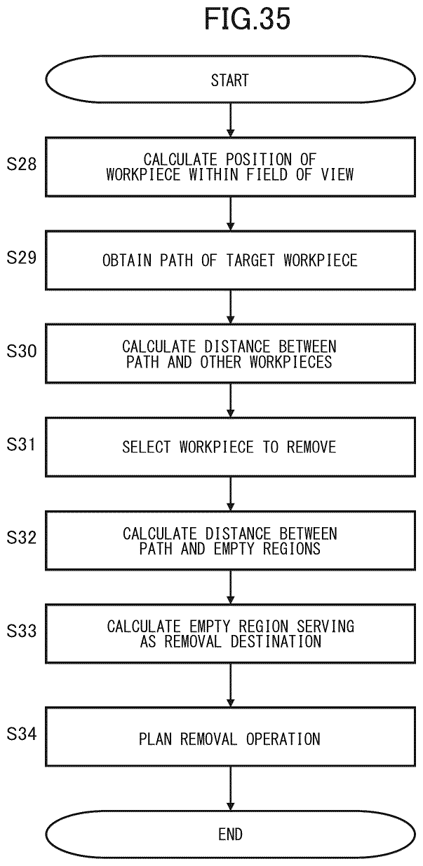

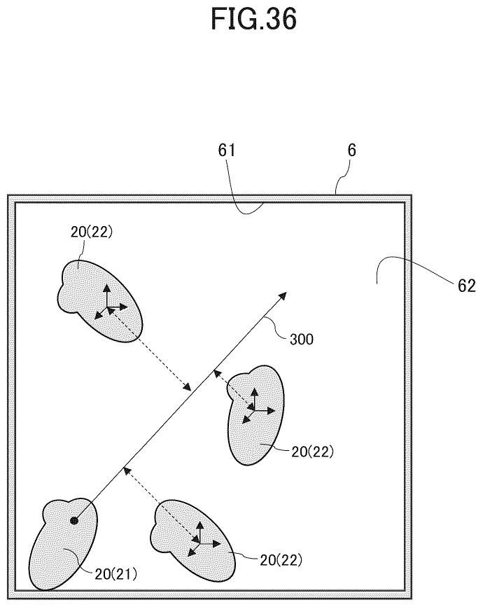

FIG. 35 is a flowchart for performing processing to move workpieces out of the path according to the third embodiment. FIG. 36 is a schematic diagram for describing the processing according to the third embodiment. The processing of flowchart of FIG. 35 is executed between the processing of step S4 and the processing of step S5 of FIG. 6.

First, in step S28, the operation planning portion 12 calculates the positions of all the workpieces 20 within the field of view of the sensor 3. The calculation method for the positions is the same method as the calculation method for the positions and postures in the processing of step S1 of FIG. 6. In addition, in the case where the positions and postures of all the workpieces 20 in the field of view of the sensor 3 have been calculated in step S1, step S28 can be omitted.

Next, in step S29, the operation planning portion 12 obtains a path 300 for moving the target workpiece 21. The target workpiece 21 is a workpiece serving as a holding target (movement target). The path 300 is a path from the calculated position of the target workpiece 21 to the position in the empty region 33 of FIG. 9. For example, the path 300 is a linear path along the external force vector applied to the target workpiece 21 in the contact information selected in step S3 of FIG. 6.

Next, in step S30, the operation planning portion 12 obtains the distance between the path 300 obtained in step S29 and the workpieces 22 other than the target workpiece 21. The operation planning portion 12 calculates the minimum Euclidean distances between the path 300 and the workpieces 22.

Next, in step S31, in the case where one of the one or more workpieces 22 is on the path 300, the operation planning portion 12 selects the workpiece as a workpiece serving as a removal target. Specifically, for example, the operation planning portion 12 performs processing of determination based on a threshold value on the distances calculated in step S30, and sets a workpiece of a distance equal to or smaller than the threshold value as a removal target. As a result of this, a workpiece present near the path 300 of the movement of the target workpiece 21 among the one or more workpieces 22 is selected as a workpiece serving as a removal target.

As the threshold value, the maximum distance 27 (in the unit of pixels) of the minimum empty region 26 illustrated in FIG. 7 defined for the target workpiece 21 used by the environment recognition portion 11 may be used. To be noted, the threshold value may be set to an arbitrary positive value by the user.

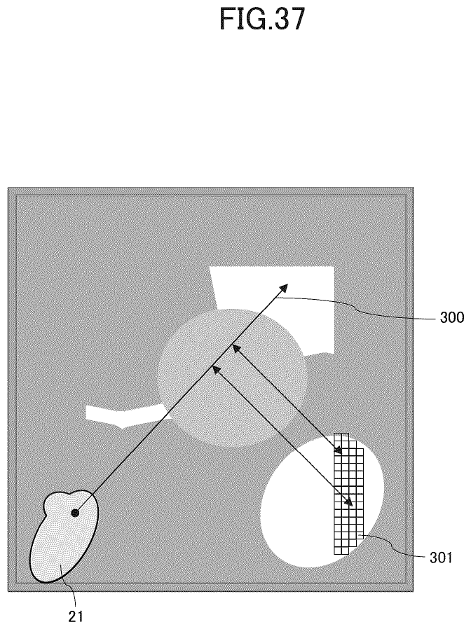

Next, in step S32, the operation planning portion 12 calculates the minimum Euclidean distance between the path 300 and each pixel of the empty region 33 recognized in step S2 of FIG. 6. FIG. 37 is a schematic diagram for describing the calculation method for the distance according to the third embodiment. The operation planning portion 12 calculates the distance between the path 300 and each pixel 301 of the white empty region in FIG. 37. To be noted, for the sake of simplicity, only some of the pixels 301 are illustrated in FIG. 37.

Next, in step S33, the operation planning portion 12 calculates the empty region serving as a removal destination of the workpiece 20. This processing may be performed by determination on the distance between the path 300 calculated in step S32 and the pixel 301 of the empty region by using a threshold value similarly to the processing of step S31.

As the threshold value, value of a half or more of the maximum distance (in the unit of pixels) of the minimum empty region 26 defined for the workpiece 20 serving as a holding target used by the environment recognition portion 11 may be used.

Finally, in step S34, the operation planning portion 12 plans the operation of the end effector 5 by a method similar to the first embodiment from the contact information of the workpiece serving as a removal target selected in step S31 and the information of the empty region serving as a removal destination calculated in step S34.

By the method described above, the operation planning portion 12 plans the operation of removing another workpiece present on the path 300 before moving the target workpiece 21. Further, the controller 13 controls the robot 7 to move other workpieces out of the path 300 before the control processing of step S5-1 illustrated in FIG. 6. As a result of this, the controller 13 can suppress interference between the target workpiece 21 and other workpieces 22 when moving the target workpiece 21, and thus facilitate the movement of the target workpiece 21 to an intended empty region 33.

### Fourth Embodiment

A fourth embodiment will be described. In the first embodiment described above, a case where the contact information is calculated by using candidates of the contact information defined in advance after the robot controller 1 has calculated the posture of the workpiece has been described. In the fourth embodiment, a method for calculating the contact information by a method using machine learning will be described.

First, a machine learning model for calculating the contact information will be described. For the machine learning model, for example, a model called U-Net is used. In U-Net, semantic segmentation in which a masked image in which a specific region of an image is blacked out is output in response to input of the image can be executed. To be noted, the model is not limited to U-Net as long as semantic segmentation is possible.

The machine learning can be performed by a computer. That is, the machine learning can be also performed by the robot controller 1, but also performed by a computer other than the robot controller 1. A case where the robot controller 1 performs machine learning will be described below as an example.

The robot controller 1 performs machine learning by using the machine learning model described above. The machine learning in the present embodiment is supervised learning. Since training data is needed as the learning data in the machine learning, a method for generating the training data will be described first.

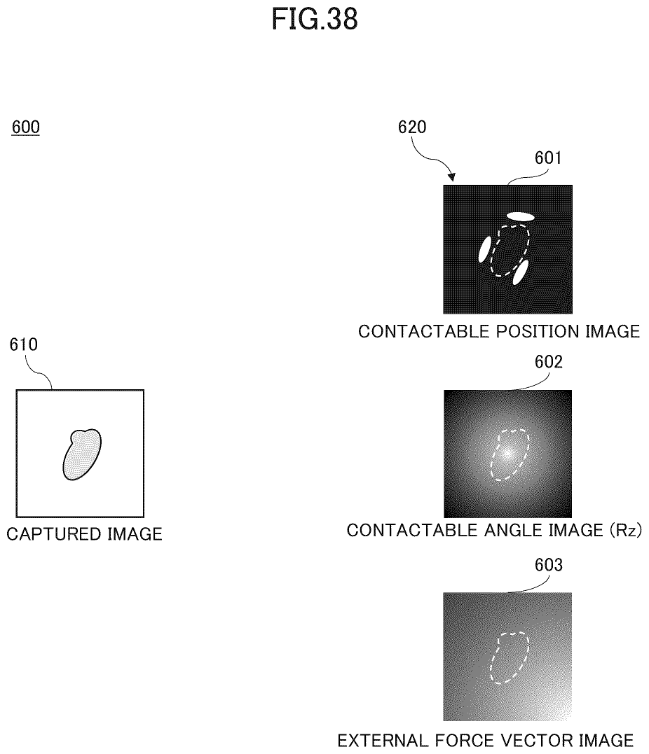

FIG. 38 is an explanatory diagram of the training data 600 according to the fourth embodiment. Each of a plurality of pieces of the training data 600 includes image data 610 and correct answer data 620. The image data 610 is input data, and is, for example, a captured image (raw image) obtained by imaging the workpiece 20. The correct answer data 620 is a set of three kinds of image data, that is, a contactable position image 601, a contactable angle image 602, and an external force vector image 603.

The three kinds of image data 601 to 603 are each generated from the image data 610 obtained by imaging the workpiece 20 disposed in the workpiece storage portion 6, on the basis of set contact information. Therefore, the three kinds of image data 601 to 603 of the correct answer data 620 included in each of the plurality of pieces of training data 600 are each equal to the image data 610 that is a captured image, in terms of the number of pixels in the longitudinal direction and the lateral direction.

The contactable position image 601 is a single-channel binary image in which positions where the workpiece displayed in the image is approachable are expressed by a gray value of 255 and other positions are expressed by a gray value of 0. To be noted, the gray values of the approachable positions and other positions do not have to be 255 and 0 as long as these positions can be distinguished from each other. In addition, in the contactable position image 601, although the position of the workpiece is indicated by a broken line for the sake of description in FIG. 38, the broken line indicating the position of the workpiece is not displayed in the actual contactable position image 601.

The contactable angle image 602 is a three-channel image indicating the values of Rx, Ry, and Rz components of the contact posture in the contact information. FIG. 38 illustrates only a channel image of the Rz component, and illustration of the channel images of Rx and Ry components is omitted. Each channel image corresponds to one of the components of the contact posture, and a gray value of a pixel of the channel image indicates the value of the corresponding one of the components of the contact posture at the position of the pixel. To be noted, Rx, Ry, and Rz need to be quantized into 255-level gradation from 1 to 255 in advance. Also in the contactable angle image 602, although the position of the workpiece is indicated by a broken line for the sake of description in FIG. 38, the broken line indicating the position of the workpiece is not displayed in the actual contactable angle image 602.

The external force vector image 603 is an image indicating the direction of the external force vector in each pixel, and is a single-channel image in which the direction of the external force vector is quantized into 255-level gradation as an angle similarly to the contactable angle image 602. In this case, the operation direction is indicated by a clockwise rotation angle where upward in the image is 0°. To be noted, the three-dimensional posture may be expressed by expanding the image to a two-channel image and indicating the vertical angle, where the vertically upward from the paper surface of FIG. 38 is 0° in the second channel. Also in the external force vector image 603, although the position of the workpiece is indicated by a broken line for the sake of description in FIG. 38, the broken line indicating the position of the workpiece is not displayed in the actual external force vector image 603.

Next, a learning method for the machine learning model using the training data 600 in the learning phase (learning processing) will be described. The input data (example data) used for machine learning is the image data 610 obtained by imaging the workpiece disposed in the workpiece storage portion 6. As the correct answer data 620 serving as a learning goal of the machine learning model, data in which the contactable position image 601, the contactable angle image 602, and the external force vector image 603 are joined in the channel direction is used. The robot controller 1 performs machine learning by using a plurality of pieces of training data 600, and thus generates a trained machine learning model.

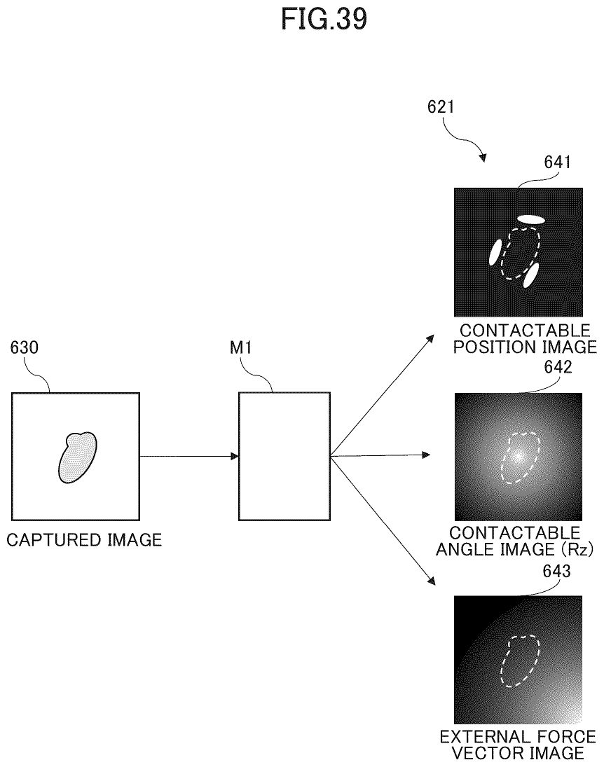

Next, a method for calculating the contact information from the output of the trained machine learning model in an inference phase (inference processing) will be described. FIG. 39 is an explanatory diagram of the inference according to the fourth embodiment. The robot controller 1 performs inference processing by using a trained machine learning model M1.

The robot controller 1 obtains the image data 630 that is a captured image from the sensor 3, and uses the image data 630 as an input data for the machine learning model M1. The robot controller 1 generates a contactable position image 641, a contactable angle image 642, and an external force vector image 643 as output data 621 in response to the input image data 630 by using the machine learning model M1.

The contactable position image 641 is an image including information of a position (third position) where the end effector 5 can come into contact with the workpiece. The contactable angle image 642 is an image including information of a posture where the end effector 5 can come into contact with the workpiece. The external force vector image 643 is an image including information of the external force applied to the target workpiece 21.

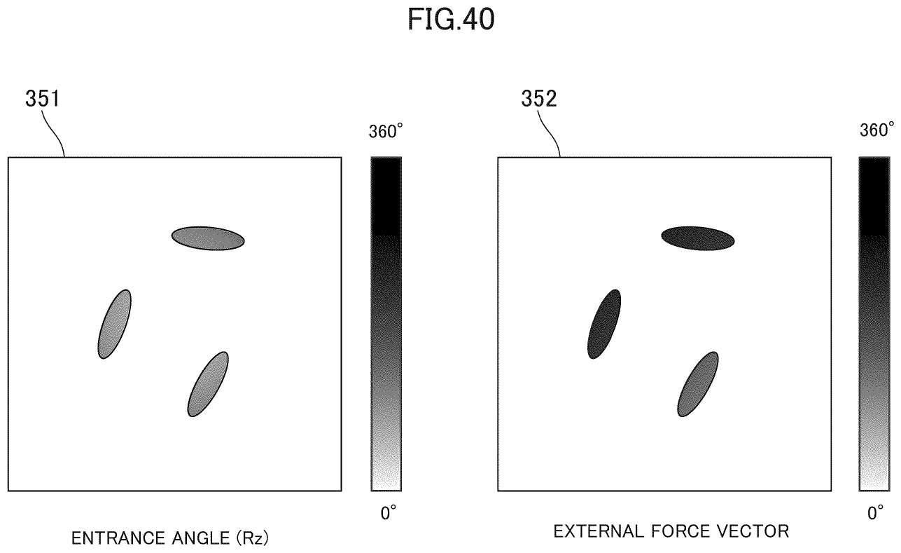

FIG. 40 is an explanatory diagram of masking processing according to the fourth embodiment. Next, the robot controller 1 generates an image 351 by performing masking processing on the contactable angle image 642 by using the contactable position image 641, and generates an image 352 by performing masking processing on the external force vector image 643 by using the contactable position image 641. The robot controller 1 obtains information of the contact position and posture 131 (FIG. 16) by obtaining the angle of the end effector at the position where the end effector can come into contact with the workpiece in the image 351, and obtains the information of the external force vector in the image 352. As a result of this, the robot controller 1 obtains contact information (that is, control information). As described above, in the images 351 and 352 subjected to masking processing, information of a pixel whose gray value is not 0 can be the contact information.

As described above, according to the fourth embodiment, the robot controller 1 can calculate the contact information by using the machine learning model M1. As a result of this, the position and posture of the target workpiece 21 does not need to be calculated, and thus the cycle time of the apparatus is improved.

### Other Modification Examples

The present disclosure is not limited to the embodiments described above, and the embodiments can be modified in many ways within the technical concept of the present disclosure. For example, at least two of the plurality of embodiments described above may be combined. In addition, the effects described in the embodiments are merely enumeration of the most preferable effects that can be obtained by the embodiments of the present disclosure, and the effects of the embodiments of the present disclosure are not limited to those described in the present embodiment.

Although a case where the robot arm 4 is a vertically articulated robot arm has been described in the embodiments described above, the configuration is not limited to this. The robot arm 4 may be various robot arms such as a horizontally articulated robot arm, a parallel link robot arm, an orthogonal robot, and the like. In addition, the present disclosure is applicable to a machine capable of automatically performing extension, contraction, bending, vertical movement, horizontal movement, turning, or a composite operation of these on the basis of information in a storage device provided in the control apparatus.

According to the present disclosure, a technique advantageous for a robot to hold a workpiece is provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-198295, filed Nov. 13, 2024, which is hereby incorporated by reference herein in its entirety.

What is claimed is:

1. A robot system comprising:
a robot including an end effector;
a sensor configured to detect a state of one or more workpieces disposed in a workpiece storage portion; and
a control apparatus configured to control the robot,
wherein the control apparatus is configured to execute
selection processing to select a target workpiece serving as a holding target of the end effector from the one or more workpieces by using a detection result obtained from the sensor,
information processing to obtain, by using the detection result, information of a region to which the target workpiece in the workpiece storage portion is movable, in a case where a holding condition that is required for the end effector to hold the target workpiece is not satisfied, and
control processing to control the robot such that the end effector comes into contact with the target workpiece to move the target workpiece to the region.

2. The robot system according to claim 1, wherein the control apparatus controls the robot such that the end effector holds the target workpiece after the target workpiece is moved.

3. The robot system according to claim 1, wherein the region is a region exposed from the one or more workpieces in an inner bottom surface of the workpiece storage portion.

4. The robot system according to claim 3, wherein the region is larger than a projected region of the target workpiece projected onto the inner bottom surface of the workpiece storage portion in a direction from the sensor toward the inner bottom surface of the workpiece storage portion.

5. The robot system according to claim 4, wherein the direction from the sensor toward the inner bottom surface of the workpiece storage portion is a direction orthogonal to the inner bottom surface of the workpiece storage portion.

6. The robot system according to claim 4, wherein the region is larger than a region obtained by expanding the projected region outward by a predetermined amount.

7. The robot system according to claim 6,
wherein the end effector includes a finger, and
wherein the predetermined amount is a thickness of the finger.

8. The robot system according to claim 1,
wherein when moving the target workpiece to the region in the control processing, the control apparatus controls the robot to move the end effector linearly.

9. The robot system according to claim 1,
wherein when moving the target workpiece to the region in the control processing, the control apparatus controls the robot to maintain a constant posture of the end effector.

10. The robot system according to claim 1, wherein in the control processing, the control apparatus causes the end effector to come into contact with the target workpiece such that a direction of an external force acting on the target workpiece is a direction toward the region.

11. The robot system according to claim 1,
wherein in a case where there is another workpiece on a path from the target workpiece to the region, the control apparatus controls the robot to move the other workpiece out of the path before the control processing.

12. The robot system according to claim 1,
wherein the region is a first region,
wherein in the information processing, the control apparatus obtains, by using the detection result, information of a second region in the work storage portion to which the target workpiece is movable, and
wherein in the control processing, the control apparatus controls the robot to move the target workpiece to the first region by bringing the end effector into contact with the target workpiece, and then move the target workpiece from the first region to the second region.

13. The robot system according to claim 1,
wherein the control processing includes:
first control processing to move the end effector from a first position to a second position opposing the target workpiece in a predetermined direction;
second control processing to move the end effector in the predetermined direction from the second position and bring the end effector into contact with the target workpiece; and
third control processing to move the target workpiece by applying an external force to the target workpiece by moving the end effector in the predetermined direction after the end effector has come into contact with the target workpiece.

14. The robot system according to claim 13, wherein the control apparatus maintains the end effector in a constant posture in the first control processing, the second control processing, and the third control processing.

15. The robot system according to claim 13, wherein the control apparatus obtains control information that includes at least information of the first position and that is to be used for controlling the robot, and uses the control information in a case of executing the first control processing, the second control processing, and the third control processing.

16. The robot system according to claim 15,
wherein the control apparatus is configured to:
obtain one or more pieces of control information from the detection result; and
obtain the control information to be used for the first control processing, the second control processing, and the third control processing from the one or more pieces of control information.

17. The robot system according to claim 15,
wherein the control apparatus is configured to:
obtain output data of a trained machine learning model by using the trained machine learning model, the trained machine learning model being configured to output, as the output data, information indicating the first position, information indicating a posture of the end effector, and information of an external force applied to the target workpiece in response to input of the detection result obtained from the sensor; and
obtain the control information by using the output data.

18. The robot system according to claim 1, further comprising:
a display apparatus,
wherein the control apparatus causes the display apparatus to display an image corresponding to the region.

19. The robot system according to claim 1, further comprising:
a display apparatus,
wherein the control apparatus causes the display apparatus to display an image including an operation plan of the robot in the control processing.

20. The robot system according to claim 1, wherein the sensor is a depth-sensing camera, and obtains image information including depth information as the detection result.

21. A control method for a robot system including:
a robot including an end effector;
a sensor configured to detect one or more workpieces disposed in a workpiece storage portion; and
a control apparatus configured to control the robot, the control method comprising:
causing the control apparatus to select a target workpiece serving as a holding target of the end effector from the one or more workpieces by using a detection result obtained from the sensor;
causing the control apparatus to obtain, by using the detection result, information of a region to which the target workpiece in the workpiece storage portion is movable, in a case where a holding condition that is required for the end effector to hold the target workpiece is not satisfied; and
causing the control apparatus to control the robot such that the end effector comes into contact with the target workpiece to move the target workpiece to the region.

22. A product manufacturing method comprising manufacturing a product by using the robot system according to claim 1.

23. A non-transitory computer-readable recording medium storing a program for causing a computer to execute the control method according to claim 21.
